(19) United States
(12) Patent Application Publication
(10) Pub. No.: US 2008/0172258 A1
(43) Pub. Date: Jul. 17, 2008

(54) System, method, and user interface for facilitating automotive glass repair and replacement

(75) Inventors: Matt Weger, Westerville, OH (US); Boppana Rao, Dublin, OH (US); Marlene Magno, Columbus, OH (US); Andre DeVerteuil, Powell, OH (US); Jason Pellegrin, Columbus, OH (US); Jelani Brandon, Lewis Center, OH (US); Richard Hochstetler, Dublin, OH (US); Craig Douglas, Dublin, OH (US)

Correspondence Address: ICE MILLER LLP, ONE AMERICAN SQUARE, SUITE 3100, INDIANAPOLIS, IN, 46282-0200, US

(73) Assignee: Safelite Group, Inc., Columbus, OH (US)

(21) Appl. No.: 11/653,584

(22) Filed: Jan. 16, 2007

(51) Int. Cl. G06F 19/00

(52) U.S. Cl. 705/4

(57) ABSTRACT

A system, method and user interface facilitating automotive glass repair and/or replacement utilizes a graphical user interface to display text that facilitates in arranging for repair and/or replacement of damaged automotive glass.

### BACKGROUND AND SUMMARY

This disclosure relates to arranging services by vendors and more particularly to arranging automotive glass repair and replacement services for those in need of the same.

Many consumers have a need for obtaining service without knowing which service provider would best suit their needs in a timely fashion. Automobile owners who suffer automotive glass damage often do not know where to obtain automotive glass repair and replacement services. For those automobile owners who choose to file a claim pursuant to the terms of their automobile insurance policy, insurance claim facilitators, and particularly automotive glass damage insurance claim facilitators, have arisen to fill the needs of both the insurance companies and their insureds for recommending service providers for repairing insured damage.

For many years, insurance companies (i.e. “clients” of the facilitator) have sought the services of and have entered into agreements with insurance claim facilitating companies such as Safelite Solutions LLC to facilitate the processing of automotive glass claims, including the repair or replacement of automotive glass for their insureds (“claimants”). Facilitators may also aid other claimants, such as persons not wishing to file an insurance claim, in obtaining automotive glass repair and replacement services from a service provider. Often facilitators own or operate service providers or are sister subsidiaries of a parent company or otherwise associated with a service provider. For instance, Safelite Group is a parent company of both Safelite Solutions LLC which is a facilitator and Safelite Fulfillment, Inc. which is a service provider. Glass damage repair facilitation, whether processed as an insurance claim or a repair or replacement job specific to Safelite or similar facilitator and/or associated service provider, typically includes the process shown for, example, in FIG. 1, which is explained in greater detail hereafter. The facilitator typically interfaces with a computer system via a user interface and with claimants, or Safelite customers for claims not submitted under an insurance policy, via a telephonic device or a computer device.

Insurance claims, as well as uninsured requests for automotive repair and replacement work specific to a facilitator and/or associated service provider (uninsured provider requests”) would be more readily facilitated if a claims center system presented a Graphical user interface to the claims processor. Additionally, insurance claims and/or uninsured provider requests would be more readily facilitated if modifications to the methods of processing claims and/or uninsured provider requests (identified as exceptions or improvements to the script modules of the process and the system architecture) were implemented.

Generally, the new system, method and computer interface provides new features that were not available in earlier claims processing or uninsured provider request systems. The prior glass claims and/or uninsured provider requests processing systems often did not provide a graphical user interface for processing insurance claims and/or uninsured provider requests and scheduling repairs or replacements for auto glass damage that was rendered in a browser enabled application. The old systems typically utilized a text based interface.

According to one aspect of the disclosure a method for facilitating automotive glass repair and/or replacement comprises a receiving step, a generating step, a displaying step and an interacting step. The receiving step includes receiving from a claimant a request to arrange for repair and/or replacement of damaged automotive glass. The generating step includes generating utilizing a scripting engine running on a computer device a graphical user interface for display on a screen of a computer device. The displaying step includes displaying the generated graphical user interface on a screen of a computer device. The interacting step includes interacting with the graphical user interface to arrange for repair and/or replacement of the damaged automotive glass.

According to yet another aspect of the disclosure a user interface for facilitating automotive glass repair and/or replacement comprises a graphical display and an input device. The graphical display displays on a computer output device and includes a plurality of screens including a script text frame for presenting script text facilitating acquisition from a claimant of appropriate information required to arrange for repair and/or replacement of damaged automotive glass and a script control frame including controls to indicate the acquired information and to control plurality of screens displayed on the computer device. The input device is configured to interact with the script control frame of the plurality of screens.

According to yet another aspect of the disclosure a system for facilitating automotive glass repair and/or replacement comprises a facilitator computer system, a display device and an input device. The facilitator computer system includes a processor running a scripting engine configured to generate a graphical user interface for display on a screen of a computer device. The display device of a computer system is coupled to the facilitator computer system for displaying the generated graphical user interface. The input device is coupled to the computer system for interacting with the graphical user interface to arrange for repair and/or replacement of damaged automotive glass of a claimant requesting to arrange for repair and/or replacement of damaged automotive glass.

Additional features and advantages of the disclosed devices and methods will become apparent to those skilled in the art upon consideration of the following detailed description of preferred embodiments exemplifying the best mode of carrying out the invention as presently perceived.

### BRIEF DESCRIPTION OF THE DRAWINGS

The illustrative devices and methods will be described hereinafter with reference to the attached drawings which are given as non-limiting examples only, in which:

FIG. 1 is a process flow diagram of a high level method of processing insured glass damage claims;

FIG. 2 is a block diagram of a call script architecture implemented by the disclosed system, utilized in the disclosed method and interacting with the disclosed user interface;

FIGS. 3-5 are depictions of screens presented by one embodiment of the graphical user interface during the claim data collection module of the method disclosed in FIG. 1;

FIGS. 6 is a depiction of a screen presented by one embodiment of the graphical user interface during the duplicate check module of the method disclosed in FIG. 1;

FIGS. 7 and 8 are depictions of screens presented by one embodiment of the graphical user interface during the coverage verification module of the method disclosed in FIG. 1;

FIGS. 9 and 10 are depictions of screens presented by one embodiment of the graphical user interface during the vehicle selection module of the method disclosed in FIG. 1;

FIGS. 11 and 12 are depictions of screens presented by one embodiment of the graphical user interface during the vehicle exception process of either or both of the glass selection or parts selection modules of the method disclosed in FIG. 1;

FIGS. 13 and 14 are depictions of screens presented by one embodiment of the graphical user interface during the glass selection module of the method disclosed in FIG. 1;

FIGS. 15 and 16 are depictions of screens presented by one embodiment of the graphical user interface during the glass selection module of the method disclosed in FIG. 1;

FIG. 17 is a depiction of a screen presented by one embodiment of the graphical user interface during a part exception process of either or both of the glass selection or parts selection modules of the method disclosed in FIG. 1;

FIG. 18 is a depiction of a screen presented by one embodiment of the graphical user interface during a part molding exception process of either or both of the glass selection or parts selection modules of the method disclosed in FIG. 1;

FIGS. 19 and 20 are depictions of screens presented by one embodiment of the graphical user interface during a coverage and benefits process of the method disclosed in FIG. 1;

FIGS. 21-23 are depictions of screens presented by one embodiment of the graphical user interface during the provider selection module of the method disclosed in FIG. 1;

FIGS. 24-35 are depictions of screens presented by one embodiment of the graphical user interface during the scheduling module of the method disclosed in FIG. 1;

FIGS. 36-39 are depictions of screens presented by one embodiment of the graphical user interface during the offer and acceptance module of the method disclosed in FIG. 1;

FIGS. 40-42 are depictions of screens presented by one embodiment of the graphical user interface during the scheduling module of the method disclosed in FIG. 1;

FIGS. 43-45 are depictions of screens presented by one embodiment of the graphical user interface during the closing statement module of the method disclosed in FIG. 1;

FIG. 46 is a depiction of a screen presented by one embodiment of the graphical user interface wherein the client requests that the customer receive an e-mail notification of their repair appointment;

FIGS. 47-48 are depictions of screens presented by one embodiment of the graphical user interface wherein the client requests that agent selection information be provided;

FIG. 49 is a depiction of a scripting engine data model of one embodiment of the scripting engine of FIG. 2;

FIG. 50 is a block diagram of one embodiment of a system for facilitating repairs to insured items with the intervention of a client representative;

FIG. 51 is a block diagram of a problem vehicle process;

FIG. 52 is a block diagram of an insurance tendered as cash sub process of a modified offer and acceptance module;

FIG. 53 is a block diagram of a second embodiment of a system for facilitating repairs to insured items without the intervention of a client representative;

FIG. 54 is a block diagram of the OEM request process;

FIG. 55 is a block diagram of the Best Available Schedule program and process;

FIG. 56-58 are depictions of available schedules for mobile locations;

FIG. 59 is a block diagram of the Schedule Override Process; and

FIG. 60-67 are depictions of screens presented by one embodiment of the graphical user interface wherein the customer desires to find a schedule that is not readily available through the override function.

### DETAILED DESCRIPTION

Many businesses provide services or deliver goods that require that the provision of the services or delivery of the goods be scheduled with a customer who must be available to accept delivery or provide access to an area where services are to be provided. While the disclosed system, method and user interface are described as being utilized to facilitate automotive glass damage repair and/or replacement, the disclosed system, method and user interface may be utilized in the above described types of businesses within the scope of the disclosure. Insurance companies often seek the services of a third party to assist, in varying degrees, in the processing of insurance claims related to automotive damage. This is done through associates or customer service representatives working in call centers answering inbound calls, or through websites accessible by claimants allowing claimants to enter information, to process auto glass related claims. These systems connect an insured or a claimant with a facility that can complete the needed repairs. While such systems process claims from insured parties, they also process claims from claimants who are not insured by an insurance company or who have suffered damage that may be attributable to the actions of an insured party. Therefore, the term claimant, as used herein, where appropriate, should be interpreted as applying to insured parties, uninsured parties, parties who have suffered damage attributable to an insured party and thus covered by the insured party's insurance policy and persons who elect not to have damage covered by an insurance policy. As shown, for example, in FIGS. 50 and 53, the disclosed systems for facilitating insurance claims and/or arranging repairs may include a system 5010 having a call center with a customer service representative having access to a telephone 5024 and a computer system 5028 or may include a computer system 5310 directly accessible by the claimant via a network without the intervention of a customer service representative. However, to simplify the description, the term “call center” is often utilized in the disclosure with the understanding that such term, where appropriate, is applicable to an automated system accessible by claimants without the intervention of a customer service representative.

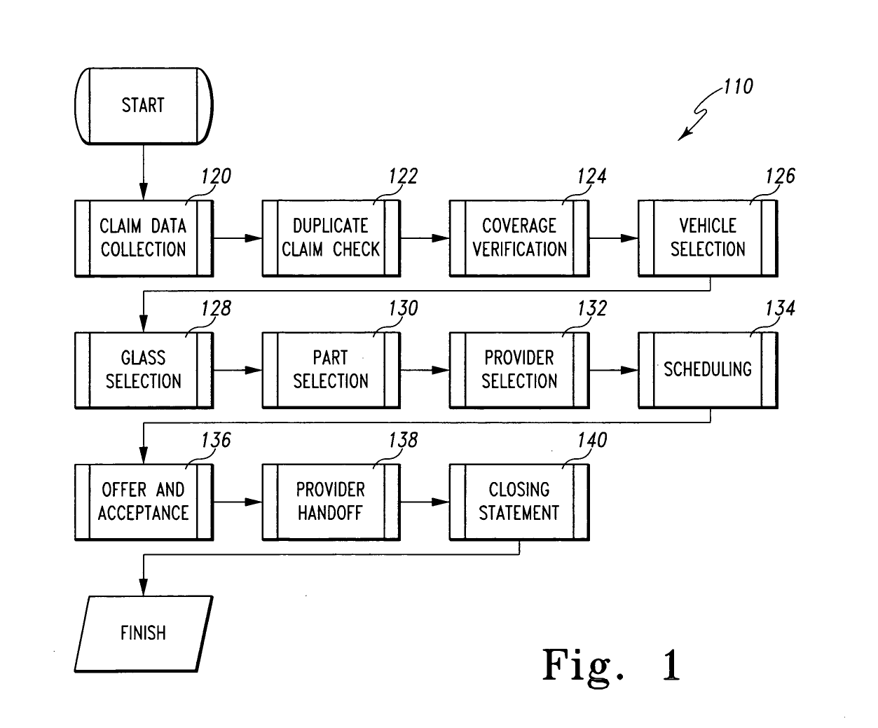

Processing an insurance claim and scheduling the necessary repairs or services sought by a claimant often includes one or more steps either alone in combination. A high level view of a method 110 for processing an insurance claim and/or scheduling repairs is shown, for example, in FIG. 1. As used herein, the term “repair” should be deemed, where appropriate, to include both repair and replacement. The high level method 110 has been utilized by call centers in one fashion or another for some time. This high level method 110 often has been automated to varying degrees by call centers since having computer systems and networks.

With regard to processing an insurance claim and/or scheduling repairs for automotive glass damage, method 110 includes claim data collection 120, duplicate claim checking 122, coverage verification 124, vehicle selection 126, glass selection 128, part selection 130, service provider selection 132; scheduling of glass repair 134; offer and acceptance 136; provider handoff 138; and generating a closing statement 140. Those skilled in the art will recognize that additional steps may be included or that one or more of the above steps may be eliminated within the scope of the disclosure. Also, the order of performance of most of the steps is generally not critical and can be performed in a different order than shown in FIG. 1, except where logically mandated. While method 110 is described with regard to processing an insurance claim and/or scheduling repairs for automotive glass damage, it is within the scope of the disclosure for method 110 to be modified for providing other insurance claim and repair services as well as other services.

Often the operation of processing an insurance claim and/or scheduling repairs 110 is initiated by collecting 120 claim data. In one embodiment, the collecting claim data operation 120 is accomplished utilizing a claim data collection module and thus, this operation, and each of the operations illustrated in FIG. 1, will be referred to as modules. Typically in claim data collection module 120, scripts, checklists or information boxes on forms are utilized to collect the necessary information to process a claim. As described hereafter, certain embodiments of the disclosed system, method and user interface improve the claim data collection module 120, by providing insurance company clients against whose policies a claimant is making a claim with a very custom level of scripting. Such custom scripting can allow the insurance company client to dictate how they would like their insured and other claimants against their policies to be greeted and asked for the necessary items to validate the coverage on their insurance policy. Typical information collected in a question/answer format during the claim data collection module 120 of the process 110 may include one or more of the: caller's name; the insured's name; the relationship of the caller to the insured; the policy number; the claim number (if available); the date of loss; the insured's contact information; the claimant's contact information, how the glass was damaged; applicable subrogation information; and other information useful in processing the claim or scheduling the appropriate repair.

To ensure that duplicate claims are not being filed, a duplicate claim checking operation or module 122 is utilized to search and validate that there are no duplicate claims that already exist for a claimant calling in to a call center or utilizing a web application to make a claim. In the duplicate claim checking module 122, the information that is collected during the claim data collection module 120 is utilized while executing a search against multiple criteria to identify any potential duplicate claims in the system. A listing of results that is sorted to provide the most relevant results at the top of the list is displayed and the customer service representative either selects a claim that was already in existence in the systems or continues creating a new claim.

Once the necessary information to validate the policy is collected and it is determined that a previous claim had not been started, the method 110 continues to a coverage verification module 124 that validates the information that was provided during claim data collection module 120 with the insurance company client. The coverage verification module 124 may implement multiple methods, such as, for example, electronic or manual verification. Electronic verification may be utilized in certain cases when appropriate electronic communication media are available to access insurance company records and databases. For example, if network connections with insurance company clients exist, multiple technologies may be utilized to access an insurance company client's system and request the status and coverage provided by the policy during the reported date of loss of the damage. Alternatively, manual verification may be utilized even when such electronic connections exist, and may need to be utilized when no electronic connection exists with clients' systems. During manual verification, the customer service representative contacts the insurance company client via telephone, or some other communication medium, such as, for example e-mail or instant messaging, to attain the policy coverage information for the date of loss provided.

Regardless of whether electronic or manual verification is utilized, the insurance company client provides the necessary coverage information back to the call center to determine what coverage was applicable for the damage. At a high level, such information may include, for example, coverage status, deductible amount, vehicles insured, VIN numbers of vehicles insured, policy holder contact information including street address; etc. Prior to completing the coverage verification module 124, the customer service representative typically validates the information with the end insured, selects the damaged vehicle if available and continues with the process flow.

Once the coverage has been determined and verified, the covered vehicle for the policy holder is selected via the vehicle selection module 126. In some cases this information is provided via the coverage verification module 124. In other cases it is completed by decoding the VIN number that is provided in an electronic communication. In other cases it is selected by the customer service representative after discussing it with the insured.

Once the vehicle that is damaged is identified, the next operation of the method 110 is to identify the glass part that was damaged. The glass selection module 128 presents the claimant, or the claim representative assisting the claimant with a series of questions, the answers to which help to determine the actual glass that was damaged on the selected vehicle. The answers to the questions presented by the glass selection module 128 may also help to identify the type of damage sustained by the claimant. Additionally, in some embodiment, the answers to the questions presented by the glass selection module 128 help to determine whether the damaged glass can be repaired or if it needs to be replaced. Certain embodiments of the disclosed system, method and user interface improve the glass selection module 128 by presenting questions regarding “problem vehicles,” i.e. vehicles that in the past have had the wrong parts identified for a repair or replacement, that help to identify the appropriate glass required to complete the replacement of the damaged glass, as explained further herein.

Once the vehicle and damaged glass is identified, the method 110 selects the part that will be used to complete the repair to the vehicle via the part selection module 130. The part selection module 130 again presents questions, the answers to which help determine which parts are required to repair or replace the damaged glass. Certain embodiments of the disclosed system, method and user interface improve the part selection module 130 by presenting questions regarding “problem vehicles,” that help to identify the appropriate parts required to complete the repair or replacement of the damaged glass, as explained further herein.

The method 110 continues with the provider selection module 132 which in certain embodiments comprises multiple programs that are supported for different insurance companies. There are several different supporting business processes that fall into one of two main categories, such categories being designated herein as “end insured has a shop preference” and “end insured does not have a shop preference.” If the claimant has a preference to have a specific shop perform the glass damage repairs, the system provides the ability for the claimant to find and designate a shop of preference. If the claimant has no shop of preference, the system provides a listing of shops that are capable of performing the repairs. In one embodiment, these shops are pre-approved by the insurance company clients for the claimant to utilize. In other embodiments, a plurality of pre-approved shops are stored in memory, such as in a database, with links to each insurance company client that has pre-approved the shop for performing repair work covered by their policies. Thus, distinct lists can be generated for each insurance company client against whose policies a glass damage claim is being made. Certain embodiments of the method 110 provide a means for insurance company clients that have established relationships with service providers to include these providers in a list when an insured has no preference. During the provider selection operation 132, a process may offer the shops specified by the insurance company to the insured as recommended options. An example of a script presented by a graphical user interface for carrying out this process is shown, for example, in FIG. 20. If one of the providers are selected, in one embodiment of the system and method, the percentage of times that a selected provider has been picked is tracked and the system attempts to balance the display of the shops to match the specified allocation distribution provided by the insurance company client.

Once a service provider is selected to complete the repairs, the next operation in the method 110 involves scheduling the work 134. If the shop selected during service provider selection operation 134 is a shop operated by the glass repair facilitator, one embodiment of the disclosed method, system and user interface presents the claimant with available schedules in their area. This service is offered either at a physical location or at a location that the insured chooses. The insured may elect to select an available appointment with the facilitator. According to certain embodiments of the disclosed systems, methods and user interfaces, insurance company clients are provided with an opportunity to elect to participate in a program wherein add-on sales of wiper blades is offered to a claimant. If so, and if the vehicle that is needing repairs matches available inventory, the system will offer to the insured at their expense to furnish and install new wiper blades during the appointment time for the glass repair. The method 110 will be modified to have the call center offer the claimant the opportunity to have their wiper blades replaced while the damage to their vehicle is being repaired. The wipers are an add-on to the work being completed and are charged directly to the claimant. The modification may be implemented by modifying the scheduling module 134.

Where the call center database 5032 includes records or the call center system 5015, 5315 has access to records 5044 of the insurance company client 5040 via a network 5034, 5032 connection regarding agents of the insurance company client, data gathered during coverage verification operation 124 or the claim data collection 120 may include a sub-process to select the agent for an insured that is calling in or otherwise presenting a claim. This sub-process occurs chronologically late in the scheduling 134 process.

Many insurance company clients have established standards and pricing for various glass repair and replacement operations. In one embodiment of the offer and acceptance module 136, a listing of service providers that have agreed to the insurance companies standards and pricing is accessed to determine if the service provider selected in operations 132 and 134 has already agreed to the insurance company client's standards and pricing (network and/or affiliate shop). If the selected provider has agreed to the standards and pricing, the offer and acceptance module 136 terminates. If a provider was selected that has not agreed to the insurance company's standards and pricing, a process is executed that provides the selected provider with the rate that the insurance company is willing to pay. In certain embodiments, the customer representative may call a shop to determine whether the shop will accept the insurance company's standards and pricing. If the provider agrees to the standards and pricing, the offer and acceptance module 136 terminates. If the shop declines this pricing, depending on the specific insurance client glass program script requirements, the claimant is then told of the price that the insurance company is willing to pay to have the work completed and that the selected provider has not agreed to be bound by those standards and pricing. In one embodiment of the offer and acceptance module 136, the claimant is permitted to request that a new provider be selected or accept the selected provider with the understanding that there is no assurance that the insurance company client will be willing to pay the full costs for the repair work performed by the selected provider. At all times during the process, the claimant is provided the ultimate choice of provider and claimant preference is honored.

One of the last operations in the method 110 is the provider handoff 138. If the selected provider is a provider operated by the repair facilitator, the scheduling of repair appointments is typically handled in scheduling the work 134. However, in a certain embodiment, when the selected provider is operated by the repair facilitator, the claimant is transferred to a scheduling representative by the provider handoff module 138. If the service provider selected is not operated by the repair facilitator, in one embodiment of the provider handoff module 138, the selected service provider is contacted and the claimant is transferred to the selected provider so that it may set up an appointment date and time for glass repair.

Finally, the generating of the closing statement module 140 provides a closing statement that, in one embodiment is a summary of the information collected and the decisions made during the fulfillment of the other operations of the method 110. Among the information provided on the closing statement may be provider completing the work, schedule information if available, deductible amounts and other pertinent information. In one embodiment of the generating of the closing statement module 140, the format and content of the generated closing statement is customized to meet the requirements of each insurance company client.

Within each of the above described high level modules, as should be apparent from the discussion so far, there is typically a plurality of sub-processes, some of which have been described generically above. These sub-processes are typically designed to accommodate business needs. The disclosed embodiments of the systems and methods for facilitating insurance claim processing and/or automotive glass repair improves upon the above described method 110 by improving or adding additional sub-process, some of which have been referenced above, to currently existing modules. The disclosed embodiments of user interfaces provide a graphical user interface for carrying out the above method 110 and/or the improvements to the method 110.

In order to improve the accuracy in which glass and parts are selected in the glass selection module 128 and the part selection module 130, certain embodiments of the disclosed systems and methods advantageously may implement a process to validate the items selected during the call flow, by implementing a problem series questions for vehicles, glass, part molding process 5110, as shown, for example, in FIG. 51. As part of problem series questions for vehicles process 5110, a listing is compiled 5112 of problem vehicles, i.e. vehicles for which parts were most often inaccurately selected based on results of prior claim processing. This list may be stored in the database 5032 to be associated with an appropriate script or scripts. While called a problem vehicle list; not all automotive glass components or parts for automotive glass components on a problem vehicle are necessary subject to misidentification. For instance, the side mirror glass on all 2003 Volkswagen Beetles may be the same while the rear window glass may differ depending on other vehicle options. Thus, the problem vehicle list may include a vehicle identification and an identification of one or a plurality of glass components that are problem glass components and/or one or a plurality of parts that are problem parts.

Once the problem vehicle list and list of inaccurately selected parts (here parts includes glass components, moldings and other parts required for glass damage replacement or repair) is complied 5112, a series of questions are formulated 5114 to assist the customer service representative or automated claims system in querying the claimant about the damage and their vehicle to facilitate identification the appropriate parts required for a repair or replacement. In an embodiment of the disclosed system, method and interface, a script is prepared 5116 from the series of questions and stored 5118 in an appropriate database 5032 or other memory locations associated with the appropriate problem vehicle and problem parts.

In one embodiment, following the vehicle selection operation 126, a determination is made as to whether the selected vehicle is a problem vehicle in operation 5120. If not, method 110 continues with glass selection operation 128. If the selected vehicle is a problem vehicle, problem glass selection operation 5128 is initiated. For each damaged glass component, problem glass selection operation queries the database to determine if the damaged glass component is a problem glass component in operation 5122. If not, it is determined whether there are any other damaged glass components in operation 5124. If a damaged glass component is a problem glass component, the database 5032 is queried to find the appropriate script components, a script is generated 5126, for example by the server 5030, 5330, the script is played 5132 and based on the answers to the question presented by the script, the appropriate glass part is selected 5134. After each appropriate glass component is selected for the damaged glass, it is determined whether there are any other damaged glass components in operation 5124. If there are additional damaged glass components, operations 5122, 5126, 5132, 5134 and 5124 are repeated. When it is determined that there are no more damaged glass components, the problem part selection operation 5130 is performed.

Following the problem glass selection process 5128, for each damaged glass component, problem part selection operation 5130 queries the database to determine if the damaged glass component requires a problem part for appropriate repair in operation 5136. If not, it is determined whether there are any other damaged glass components requiring parts in operation 5138. If a damaged glass component repair requires a problem part, the database is queried to find the appropriate script components, a script is generated 5140, for example by the server 5030, 5330, the script is played 5142 and based on the answers to the question presented by the script, the appropriate part is selected 5144. After each appropriate part is selected for the damaged glass, it is determined whether there are any other parts required for the glass repair in operation 5138. If there are additional parts required, operations 5136, 5140, 5142, 5144 and 5138 are repeated. When it is determined that there are no more damaged glass components, the provider selection operation 132 is performed.

Thus, during the glass selection module 5128 and/or the part selection module 5130, when a problem vehicle has been identified in the vehicle selection module 126 the server 5030, 5330 generates scripts to be presented to the claim representative 5020 and/or on the graphical user interface 208 when a “problem vehicle” is identified as having incurred glass damage. This sub-process 5110 was implemented for assisting the customer service representative in discussing the vehicle, the damaged glass part, and the part itself. Examples of the problem series questions that may be presented in the script generated are: “Is the vehicle equipped with On Star?;” “Do the windshield wipers automatically increase in speed as the quantity of rain increases?;” “Does your rearview mirror on the windshield dim automatically when a car is behind you?;” and “Does your vehicle have the Heads-Up Display option which projects an image of your speedometer and other gauges onto the windshield?.”

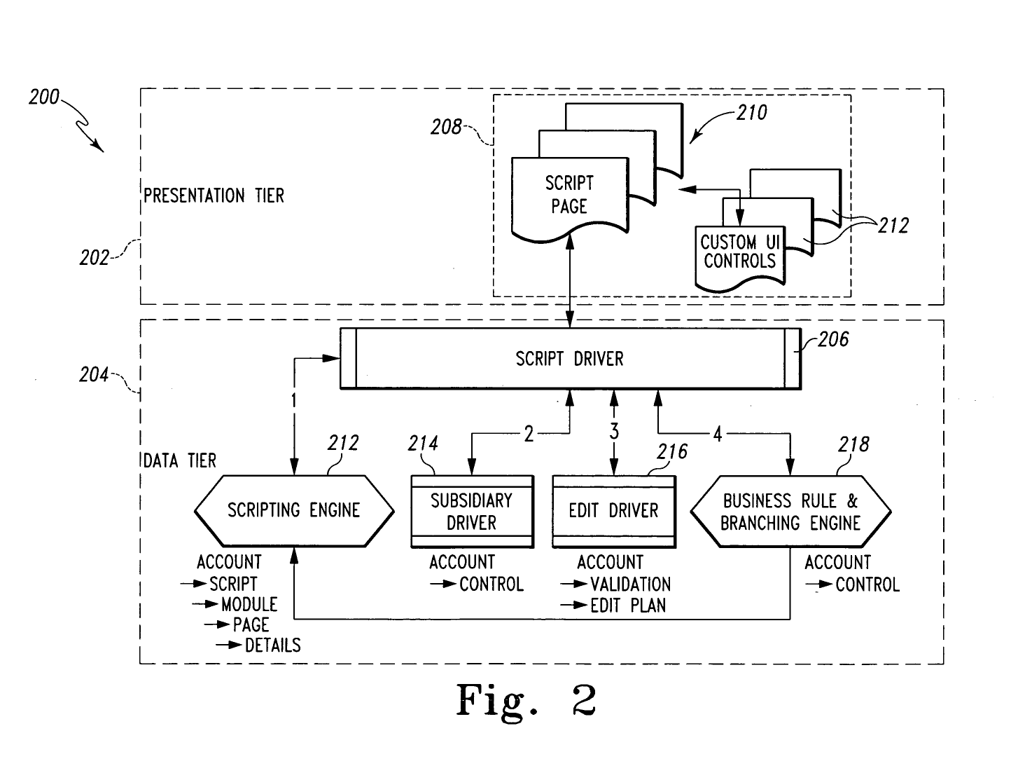

Examples of embodiments of screens presented in the user interface 208 when a problem vehicle has been identified in vehicle selection module 126 are shown in FIGS. 11-12 and 17-18, discussed below. The above identified scripts may be generated by utilizing a call script architecture 200 described below with reference to FIG. 2.

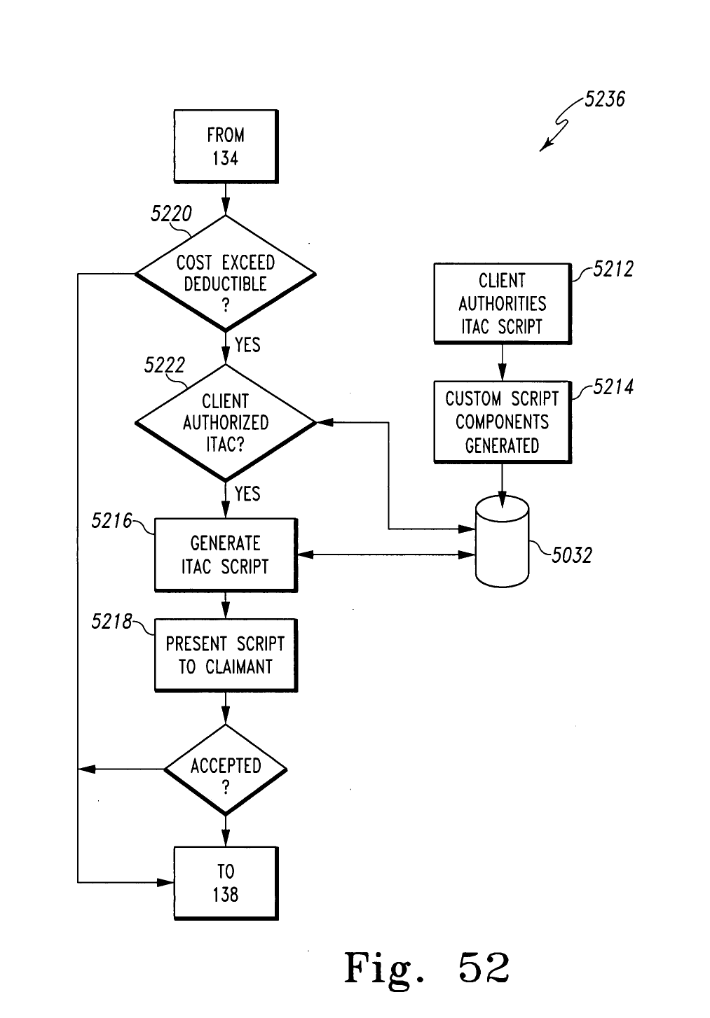

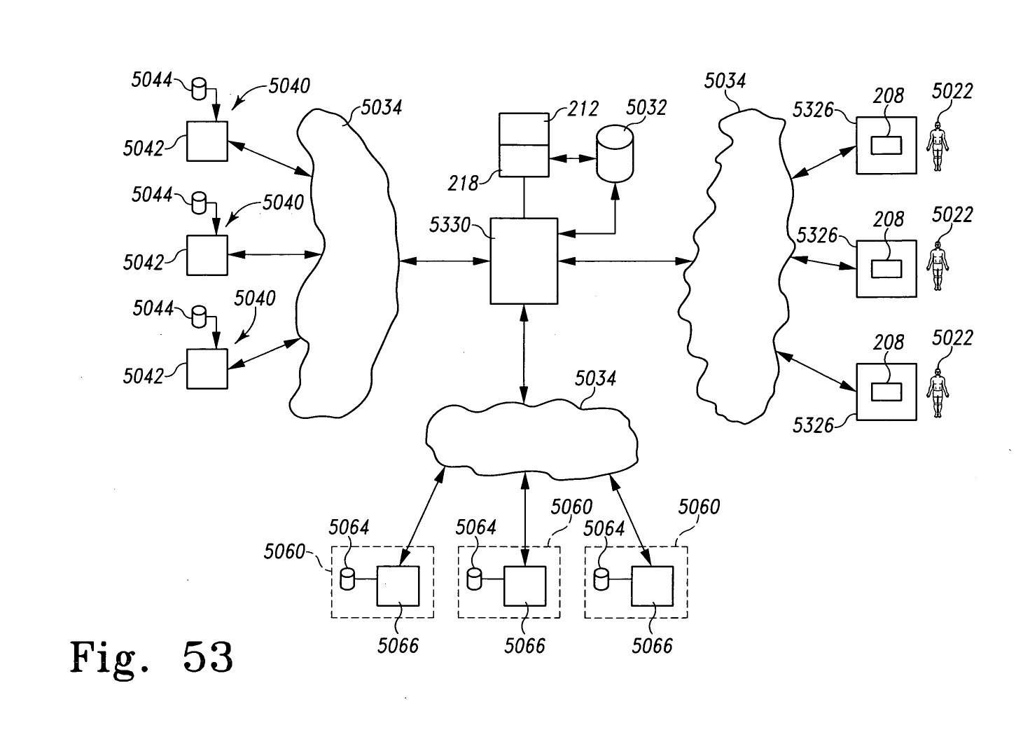

In one embodiment of the disclosed method, the scheduling module 5236 is modified to include an insurance tendered as cash (ITAC) process as, shown, for example, in FIG. 52. An insurance company client may require 5212 custom script components to be generated 5214 and stored in a database 5032 for generating 5216 a custom script to be presented 5218 to an insured claimant during the scheduling module 5236 when it is determined 5220 that the insured's deductible amounts that exceed the price of the job to repair the damage and a database check 5222 determines that the client has authorized the ITAC script to be presented. During the script presentation 5218, in a customer service representative implemented system 5010, the customer service representative 5020 explains to the insured claimant that it is not necessary to go through their insurance company because their insurance company has a relationship with a glass provider that will perform the service for less than their deductible amount. In a system for processing claims without customer service representative intervention 5310, the script is generated on the user interface of the claimant device. In one embodiment of sub-process 5236, the sub-process is only effective for insurance company clients that have approved of the program. In alternative embodiments, the ITAC process may be implemented any time the repair estimate exceeds an insured claimant's deductible amount. The above identified scripts may be generated by utilizing a call script architecture 200 described below with reference to FIG. 2.

For example, if an insured calls in to report a broken windshield for a 2000 Ford Econoline van. And it is determined that the policy that the insured carries has a $500 deductible but the job can be completed for $276, the customer service representative explains that the insurance out-of-pocket deductible amount is $500, but the job will only cost $276 to complete by a service provider recommended by the insurance company.

Some of insurance company clients have endorsements on their insurance policies that indicate that an insured has paid for an additional benefit on their policy. One such endorsement permits the insured to have Original Equipment Manufacturer (“OEM”) parts used when replacing parts to a damaged vehicle. In one embodiment of the disclosed systems, methods and user interface the provider selection operation 132, scheduling operation 134, glass selection operation 128 and the parts selection operation 130 are modified to address the situation in which an insurance company client provides an OEM endorsement and an insured claimant has purchased the OEM endorsement.

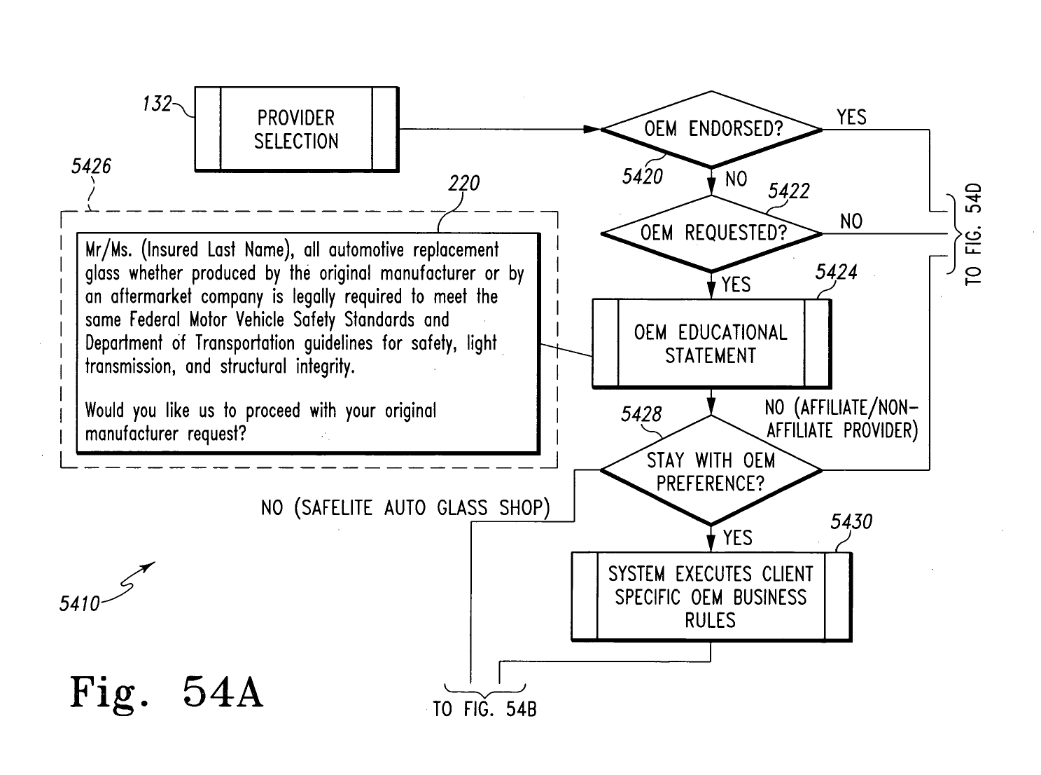

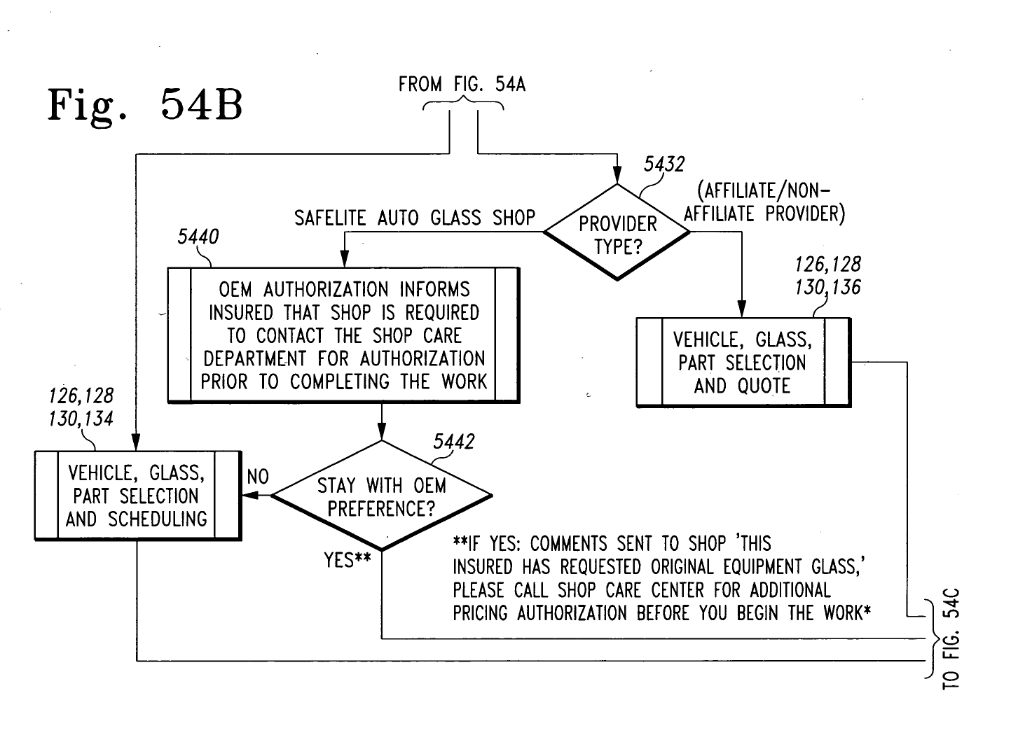

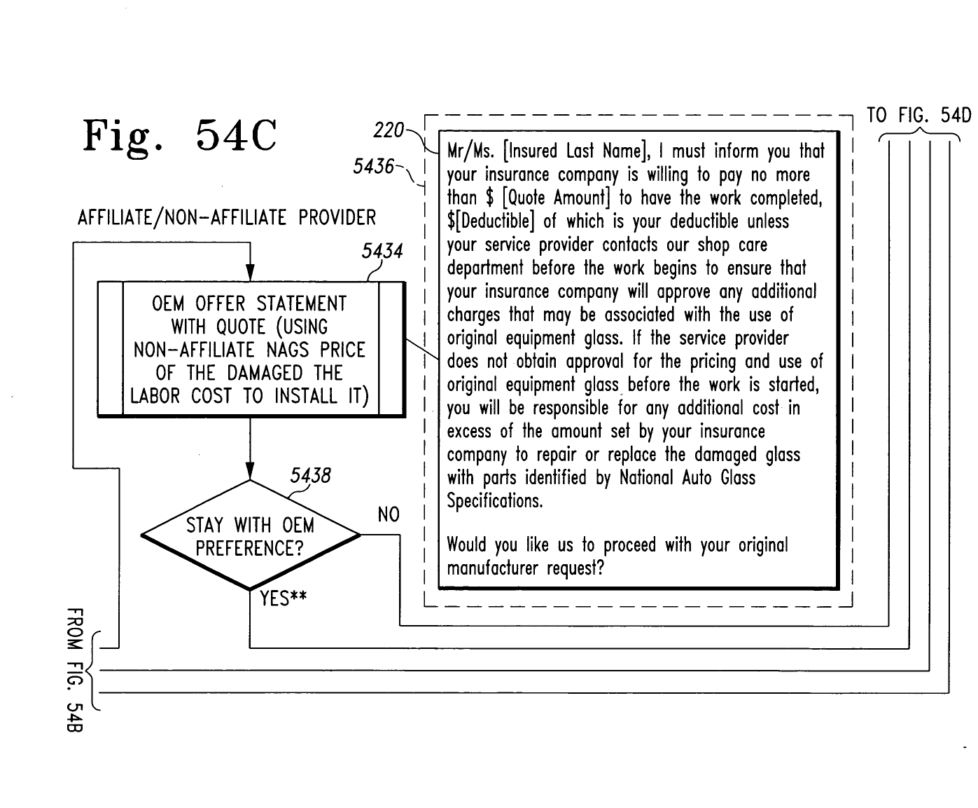

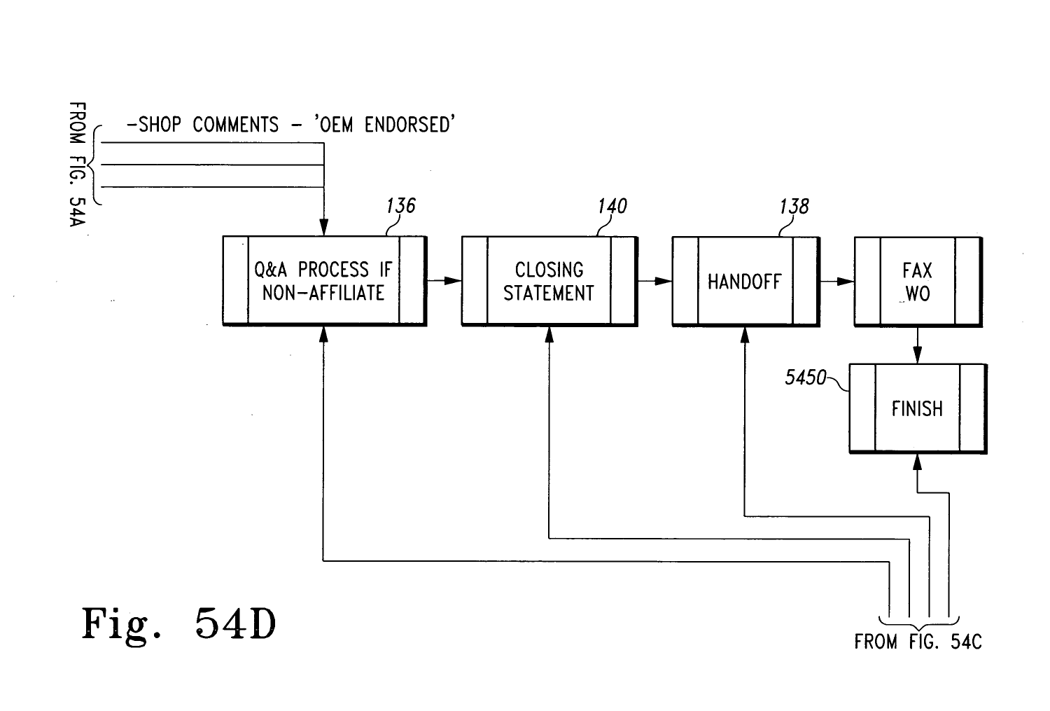

As shown, for example, in FIG. 54, following the completion of the provider selection process 132 the method 110 is modified to include an OEM process 5410. Initially, a determination 5420 is made as to whether the claimant has an OEM endorsement. If there is no OEM endorsement on the claimant's policy, it is determined 5422 whether OEM parts have been requested by the claimant. If there is no OEM endorsement or request, the offer and acceptance process. 134 is performed if the selected provider is a non-affiliate of the facilitator or client. If it is determined in step 5422 that the claimant has requested OEM parts, an OEM educational statement 5424 is presented to the claimant. The system generates a GUI screen 5426 that includes text in the script text frame 220 that explains that all automotive replacement glass meets the same federal standards. After the presentation of the OEM educational statement 5424, it is determined 5428 whether the claimant still desires to have OEM parts used to repair their vehicle. If not and the selected provider is not affiliated with the facilitator, the offer and acceptance process 134 is performed. If the claimant no longer desires OEM parts and the provider is affiliated with the facilitator, the vehicle selection 126, glass selection 128, part selection 130 and scheduling 134 processes are performed before finishing 5450 the method. If in step 5428 it is determined that the claimant continues to desire that OEM parts be utilized for the repair, the system executes specific OEM business rules in step 5430. In step 5432 it is determined whether the selected provider is associated with the facilitator or if the selected provider is an affiliate or non-affiliate provider of the insurance client. If it is determined in step 5432 that the selected provider is an affiliate or non-affiliate provider of the insurance client, then the vehicle selection 126, glass selection 128, part selection 130 and offer and acceptance 136 processes are performed before presenting an OEM offer statement 5434. During the presentation of the OEM offer statement 5434, a quote for replacement services is provided using non-affiliate National Auto Glass Specifications (“NAGS”) price of the damaged part and the labor cost to install it. A GUI screen 5436 having text in the script text frame 220 is presented by the system to facilitate performance of the OEM offer statement 5434. That text includes a query regarding whether the claimant wishes to proceed with their OEM request. In step 5438, it is determined whether the claimant wishes to stay with their OEM preference. If so, the closing statement process 140 is performed. If the claimant no longer wishes to continue with their OEM preference, the offer and acceptance process 134 is performed. If it is determined in step 5432 that the selected provider is associated with the facilitator then an OEM Authorization statement 5440 is presented to the claimant. During the OEM Authorization statement, the claimant is informed that the provider is required to contact the shop care department for authorization prior to completing the requested replacement work. Following the OEM authorization statement 5440 the claimant is asked whether they wish to continue to request OEM parts for the desired repair in step 5442. If in step 5442 the claimant indicates that they no longer desire that OEM parts be utilized during the glass replacement, the vehicle selection 126, glass selection 128, part selection 130 and scheduling 134 processes are performed before finishing 5450 the method. If the claimant continues to request the use of OEM parts, the handoff process 140 is performed and the provider is advised that OEM parts have been requested and that additional pricing authorization should be obtained from the claimant's insurance company prior to beginning work.

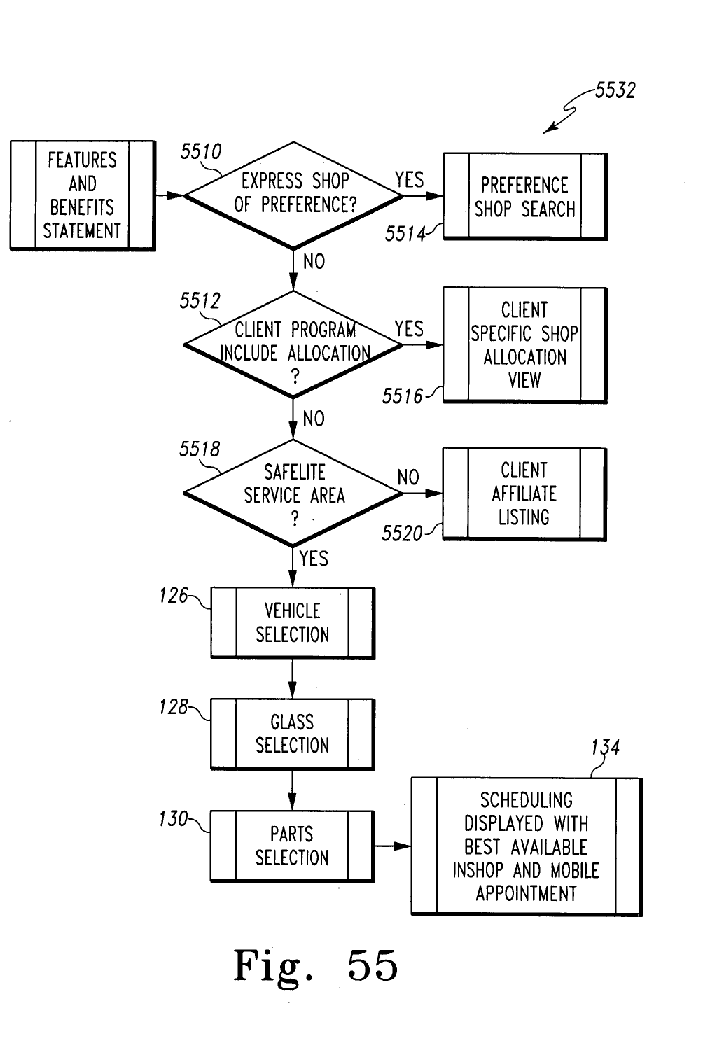

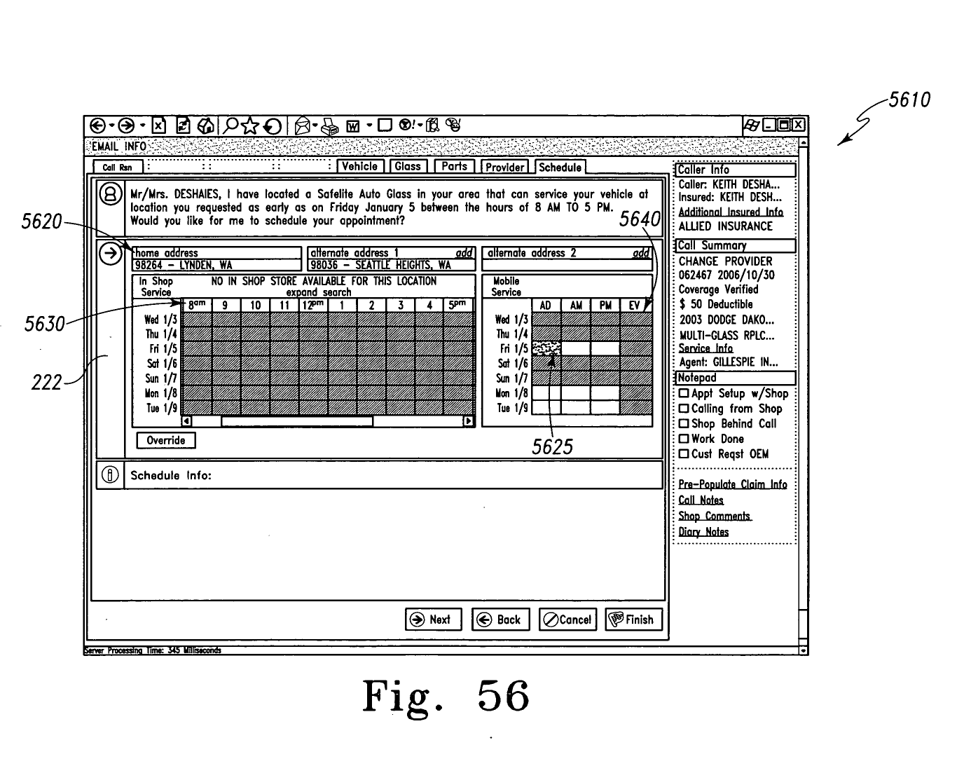

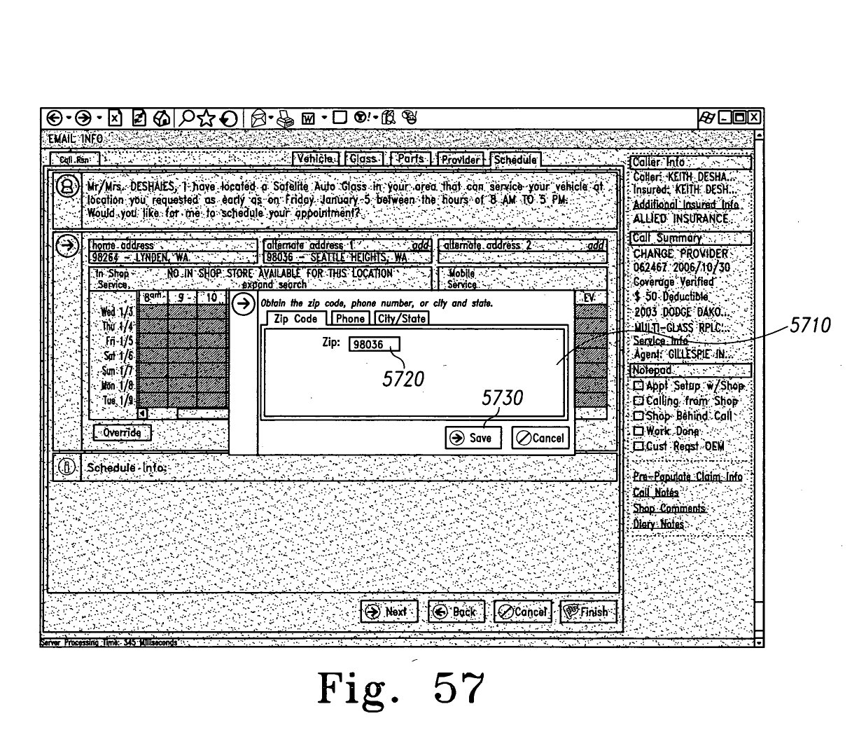

According to certain embodiments of the disclosed systems, methods and user interfaces, the claimant will be offered the best available schedule for the repair to be completed in a modified provider selection module 5532, as shown, for example, in FIG. 55. The system will start with a function in provider selection 132 for determining whether the insured has a preference for a given shop is indicated in step 5510. If a preference is indicated, a preference shop search 5514 is performed to determine the availability for service at the preferred shop. If there is no shop of preference, the system will then check to make sure that the insurance client does not have a pre-defined percentage allocation to pre-approved shops in step 5512. If such a plan exits the appropriate client specific allocation view 5516 is presented so that repair work may be scheduled. If the insurance client program does not include allocation, it is determined whether the claimant is in the facilitator service area in step 5518. If not, an insurance client affiliate listing is presented 5520 so that service can be arranged with an appropriate provider. If the claimant is in the facilitator service area, the system will then continue through vehicle selection 126, glass selection 128, part selection 130 and on to scheduling 134 presenting the best available schedule for both a physical store location as well as for service to the home address collected in the claim data collection module 120. The claimant can provide as many physical addresses that they are interested in seeing schedules for to the customer service representative who, in turn, enters them into the system to display applicable schedules. In one embodiment of the modified provider selection module 5532 the insurance company client is provided with the ability to jump out and find a specific provider if that presented schedule is not acceptable.

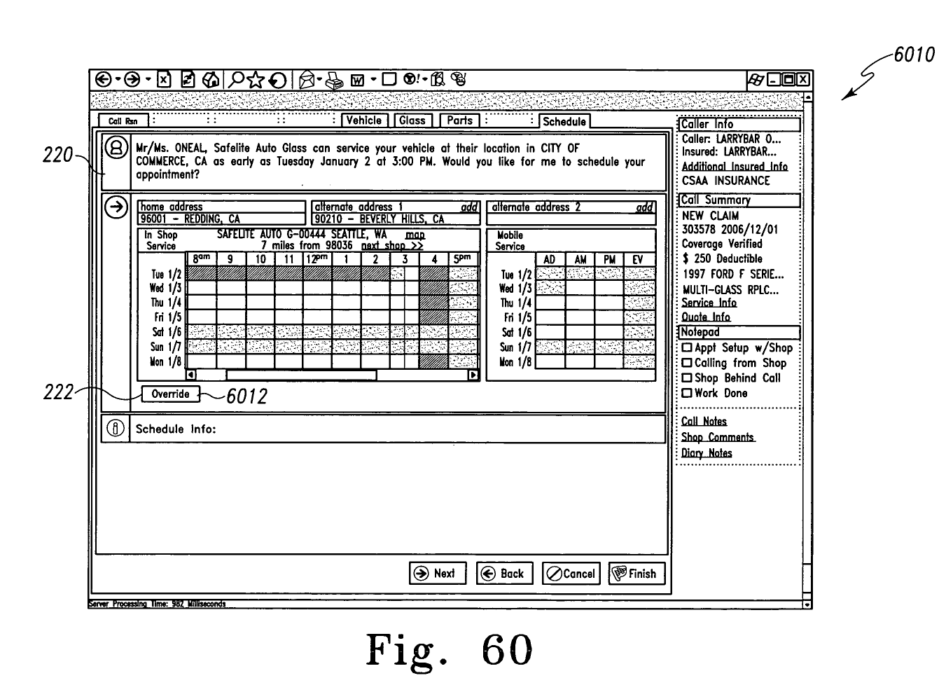

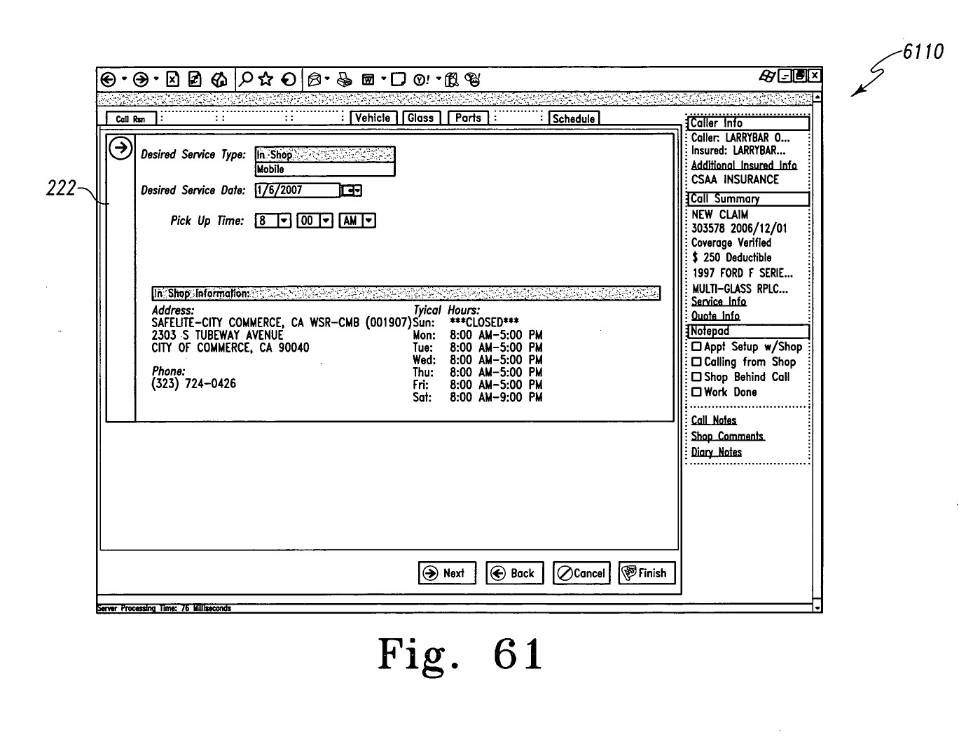

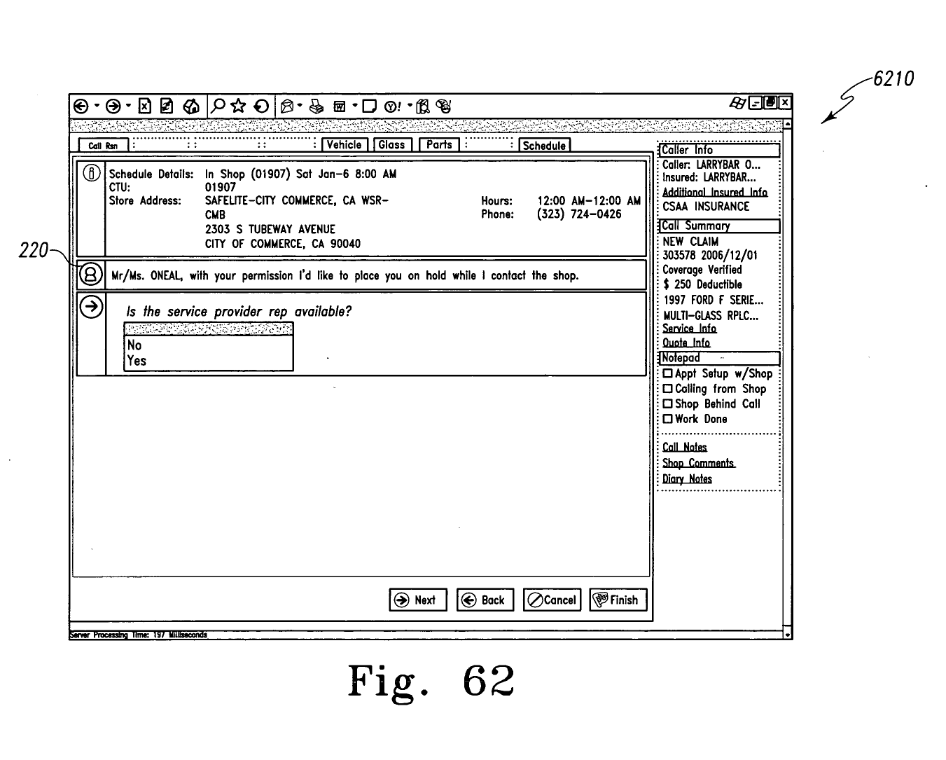

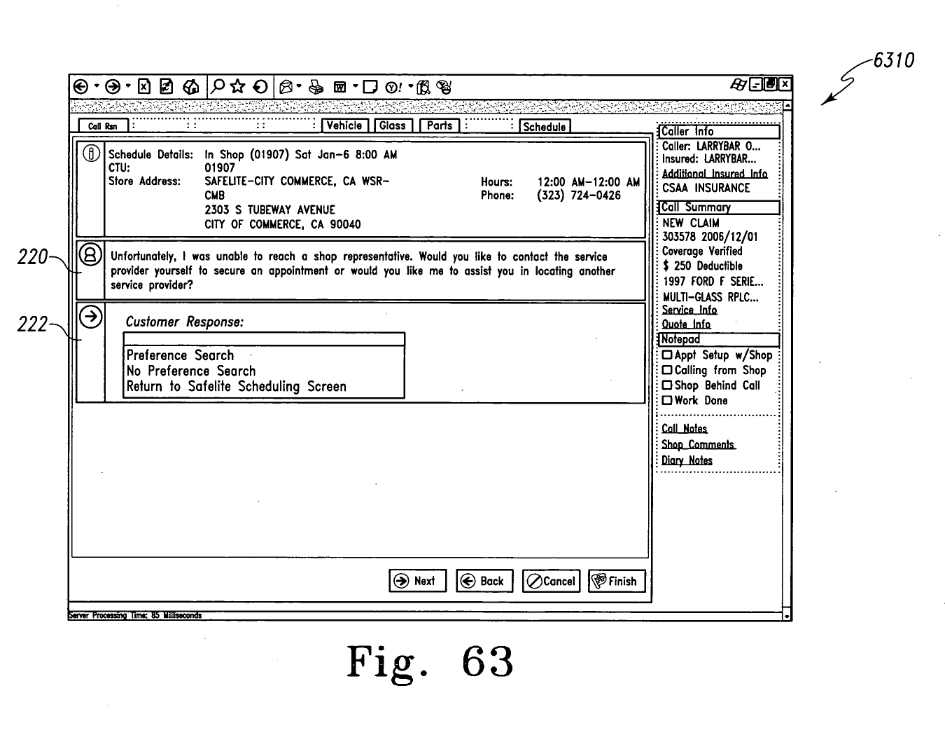

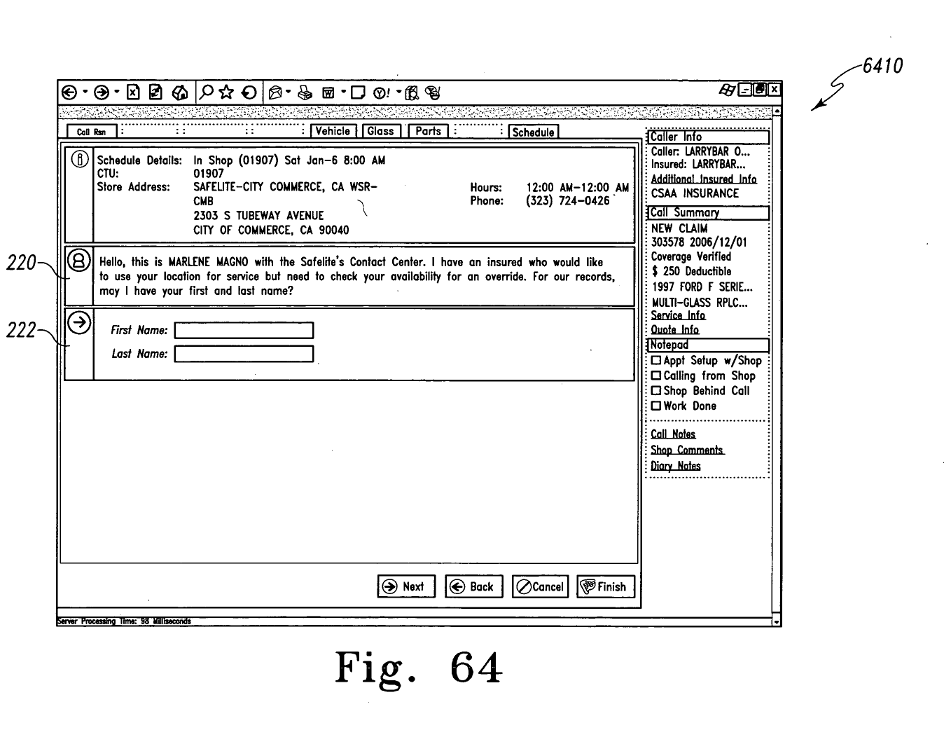

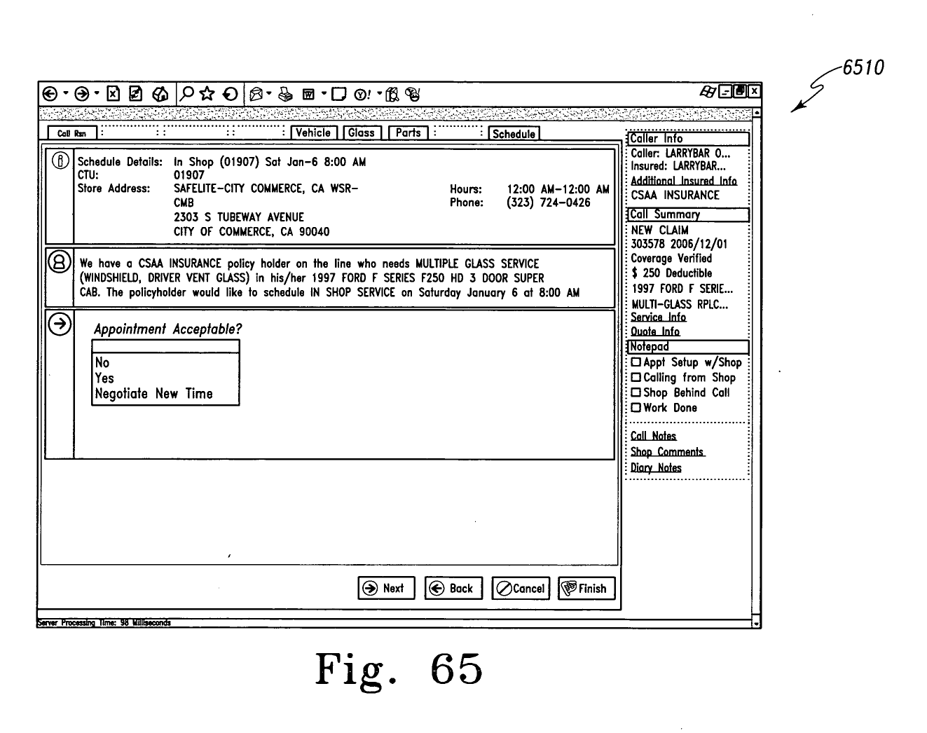

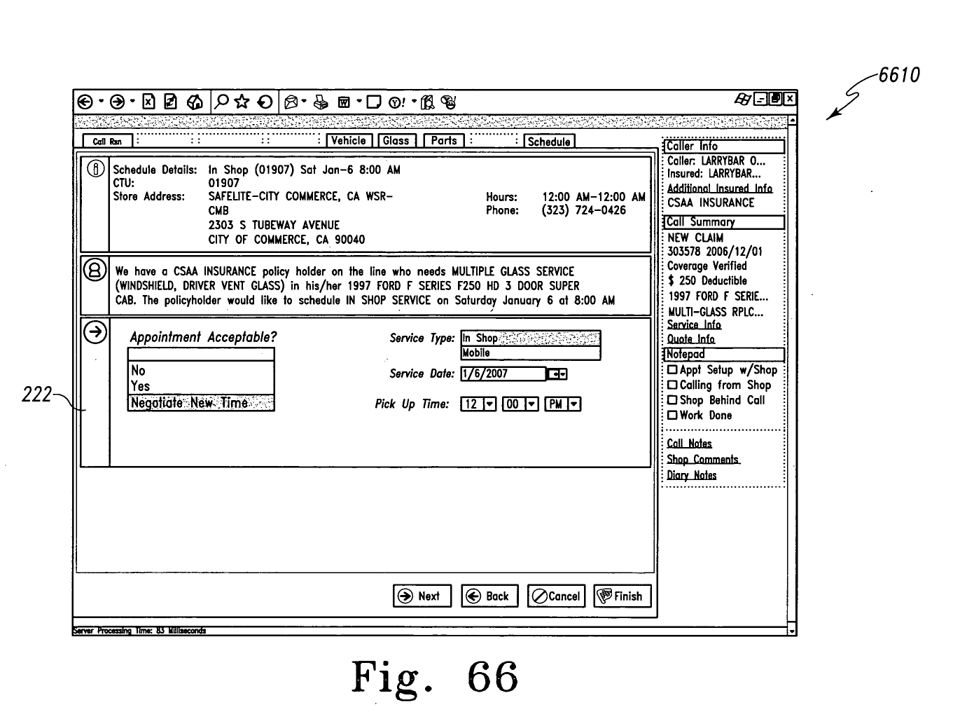

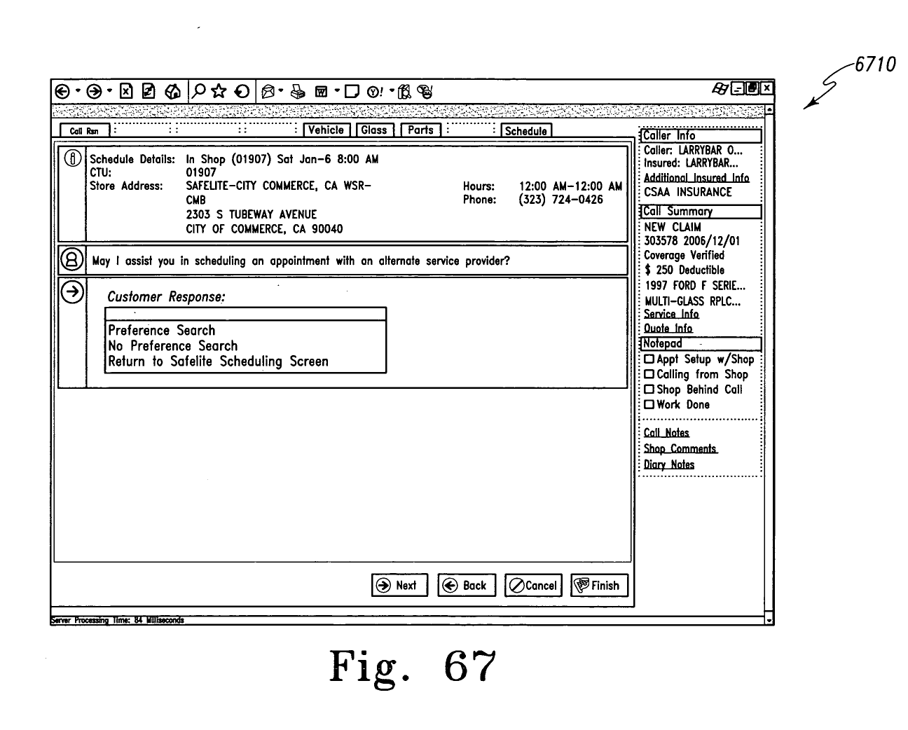

If an insured is unable to find an acceptable appointment when reviewing the facilitator's scheduling options, the scheduling operation 134 may include a sub-process that provides the ability to contact the provider directly and to determine the claimant's desired timeframe for the work to be completed, as shown, for example, in FIG. 59. Initially, as shown, for example, in FIG. 60, the system causes a GUI screen, such as GUI screen 6010 to be presented, displaying appointment availability and including text in the script text frame 220 which prompts a query 5910 (FIG. 59) as to whether the claimant's preferred appointment is available. When the insured is unable to find an acceptable appointment with a facilitator's shop, the customer service representative (“CSR”) can click on the Override button 6012 in the script control frame 222, to contact the facilitator's shop directly to determine whether the shop can accommodate the insured's schedule request. Clicking on the override button 6012 causes the system to present an override GUI screen, such as screen 6110, shown, for example, in FIG. 61. On the override page 6110, the CSR fills in the insured's preference on service type, date and time in the script control frame 222 thereby capturing 5912 that information (FIG. 59). The system will first verify 5914 that the schedule is not available. If it is determined in step 5916 that the appointment is not available, the a GUI screen 6210 is presented wherein the CSR will be asked via text in the script text frame 220 to receive permission from the claimant for the CSR to contact 5918 the facilitator's shop or provider to negotiate an appointment time. It is then determined whether the provider can be contacted in step 5920. If provider cannot be contacted, the claimant is given an option to contact the provider, select a different schedule or a different provider 5922. A GUI screen, such as GUI screen 6310 is generated including text in the script text frame 220 that advises the claimant that the provider could not be contacted and indicating the options provided to the claimant, as shown, for example, in FIG. 63. GUI screen 6310 also includes a control in the script control frame 222 whereby the claimant's response can be recorded so that the system will present the appropriate GUI screen base on the claimant's response. If provider is available, the shop representative's name is captured 5924 and the purpose of the call is explained. The system generates a GUI screen, such as screen 6410, which includes text in the script text frame 220 to facilitate obtaining the shop representative's name and text boxes in the script control frame 222 for entering of the captured information, as shown, for example, in FIG. 64). The details of the job are given 5926 to the shop and availability of an appointment is determined 5928 by the CSR. A GUI screen, such as screen 651, is generated by the system with text in the script text frame 220 indicating the date and time of the desired appointment and a selectable list in the script control frame 222 for indicating whether the date and time are acceptable to the provider, as shown, for example, in FIG. 65). If the appointment is accepted, then the appointment is scheduled 5930 and the process continues with the rest of the call until done. If the provider has other available schedule on the same day, the CSR can select the “Negotiate New Time” option from the selectable list in the script control frame 222 of screen 6510 and negotiate an appointment time between the provider and the claimant. Selecting the Up, “Negotiate New Time” option from the selectable list in the script control frame 222 of screen 6510 causes the system to generate a GUI screen such as screen 6610 including controls in the script control frame 222 that allow the service type, service date and service time to be indicated, as shown, for example, in FIG. 66. Once a new appointment time is negotiated, the appointment is scheduled 5930 and the CSR proceeds with the rest of the call until done. If there is no acceptable appointment, the insured is informed 5932 of this and is given an option to select a different schedule or a different provider in step 5922. A GUI screen, such as screen 6710 is generated by the system to aid the CSR in informing the client that an appointment could not be scheduled and offering to schedule an appointment with an alternative provider, as shown, for example, in FIG. 67.

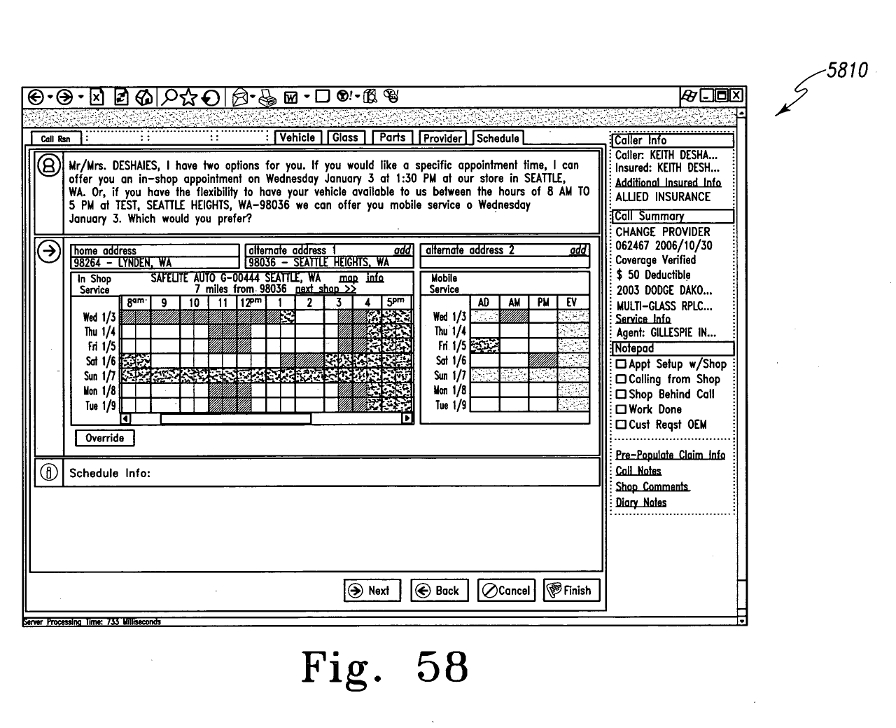

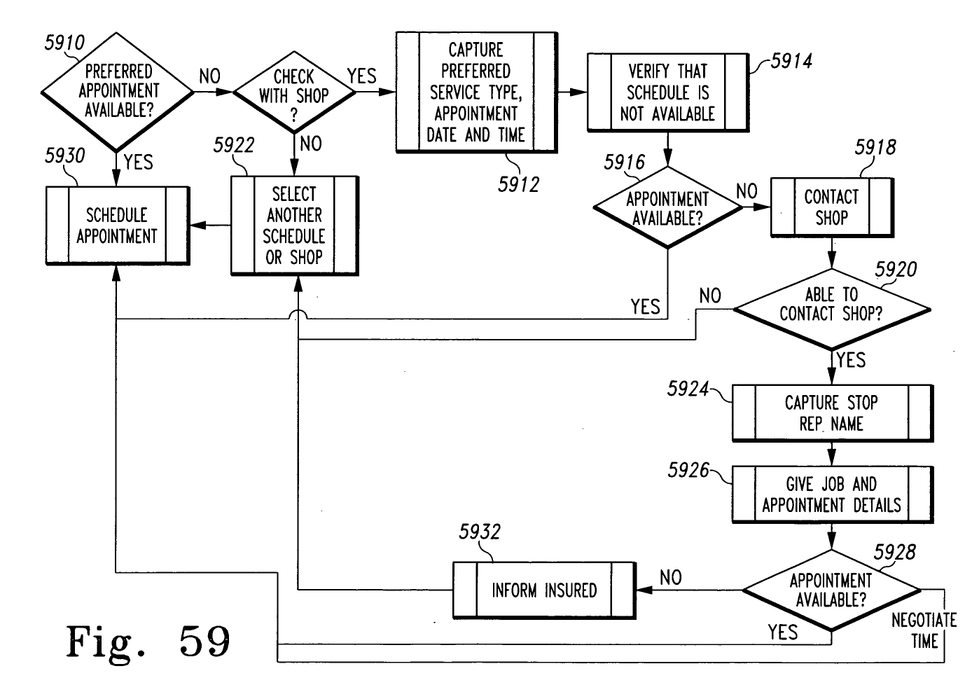

According to certain embodiments of the disclosed systems, methods and user interfaces, the scheduling process 134 is modified to provide a claimant with the ability to view the availability of appointments at multiple locations. This multi-location appoint availability scheduling sub-process 5634 assists the insured by allowing them to check to see what may be most convenient for the insured. This is commonly used to determine whether a job will be performed at an insured's home, place of business or to find the nearest location for that insured on their terms. On the main page of the GUI screen 5610 generated by the modified scheduling module, there are three address boxes 5620 in the script control frame 222 that are presented to the user. These are the home address, alternate address 1 and alternate address 2. Home address, which is read-only, displays the primary address of the claimant. The schedule presented is the schedule for the address that is highlighted. The GUI screen 5610 shows the availability for zip code 98264—Lynden, Wash. The example shown in the GUI screen 5610 assumes that there are no shops in the location requested that offer in-shop service in frame 5630 but there are available mobile appointments indicated in frame 5640. If the claimant prefers an in-shop service or would like to look at availabilities in another location, such as near work or where the family is vacationing, the user can click on the edit link 5625 to enter a different location. Clicking on the edit link 5625 causes the system to generate an address popup box 5710, as shown, for example, in FIG. 57. The user can enter a new location by either zip code, city/state or telephone number by clicking on the appropriate tab in the address pop-up box 5710 and enter the appropriate information in the text box 5720. Clicking on the Save button 5730 will save the information on the alternate address box. Upon exiting the address popup, a call to the scheduling interface is made based on the new location. The GUI screen 5810 shown in FIG. 58 shows the appointment availability for zip code 98036—Seattle Heights, Wash. with the alternate address box for the given location highlighted. In the illustrated embodiment, the user can enter up to two alternate addresses.

The call script architecture 200, as shown, for example, in FIG. 2 is a custom architecture that allows for the tailoring of the insurance company client's program to assists the claimant with getting their damage repaired. A preliminary inquiry is conducted to determine which insurance company client the claimant or insured desires to make a claim against. This preliminary inquiry may be direct or indirect. In one embodiment, separate telephone numbers or URLs are provided for accessing the call center for each insurance company client. From there, the system determines which custom script is presented by the call script architecture 200 to the call center operator or generated on the claimant's user screen. A live call center operator, that may or may not be a customer service representative, may orally present the preliminary question and, based upon the vocal response of the claimant, designate the appropriate script to be utilized by the claim data module by inputting information through the user interface of the call center system. It is within the scope of the disclosure for other methods to be utilized to determine which custom script should be utilized.

One embodiment of the call script architecture is disclosed, for example, in FIG. 2. The disclosed call script architecture 200 is composed of a presentation tier 202 and a data tier 204. One embodiment of the data tier 204 includes a script driver 206, a scripting engine 212, a subsidiary driver 214, an edit driver 216 and a business rule and branching engine 218. One embodiment of the presentation tier 202 includes a plurality of script pages 210 for presentation on a user interface 208 and custom user interface controls 212. The architecture 200 may be designed to support insurance client-specific business process flows. The script driver 206 acts as the intermediary between the presentation tier 202 and the data tier 204. The script driver 206 directs the flow of the presentation tier 202 based on information passed from the data tier 204.

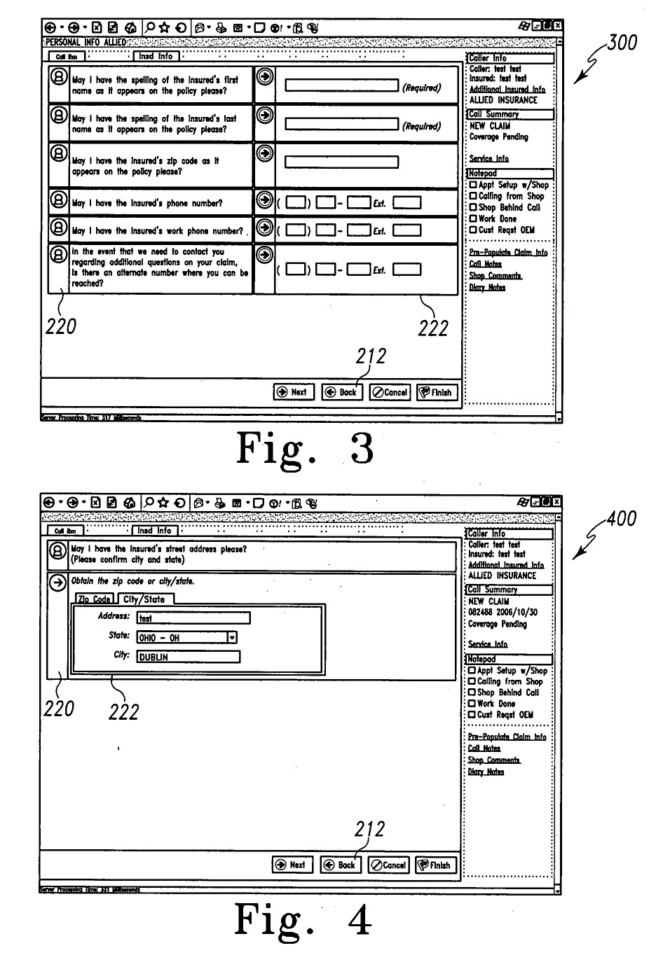

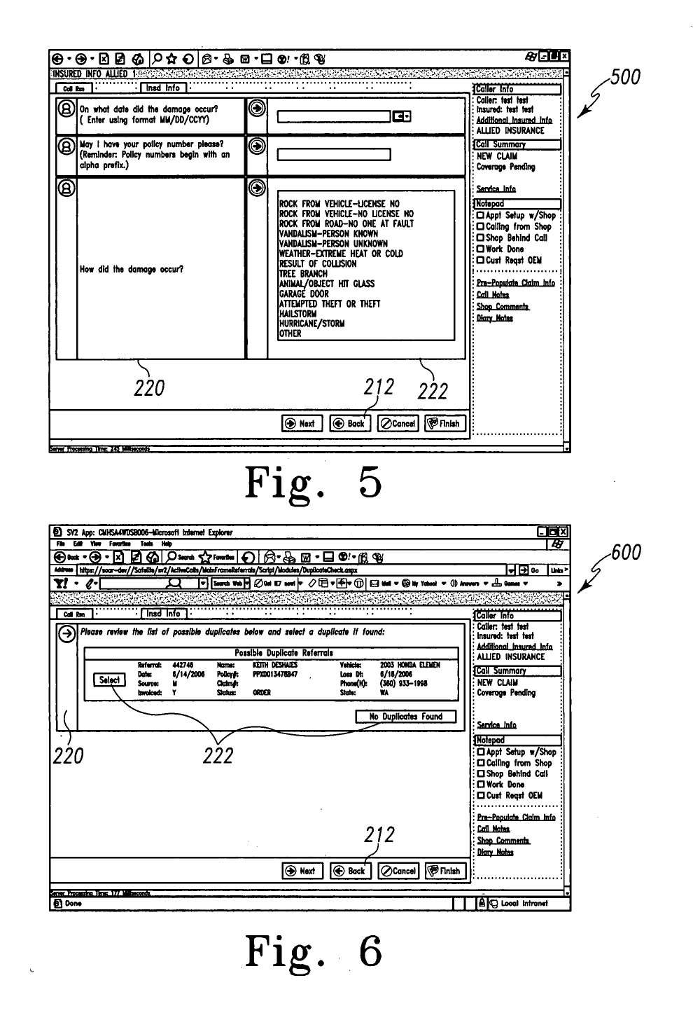

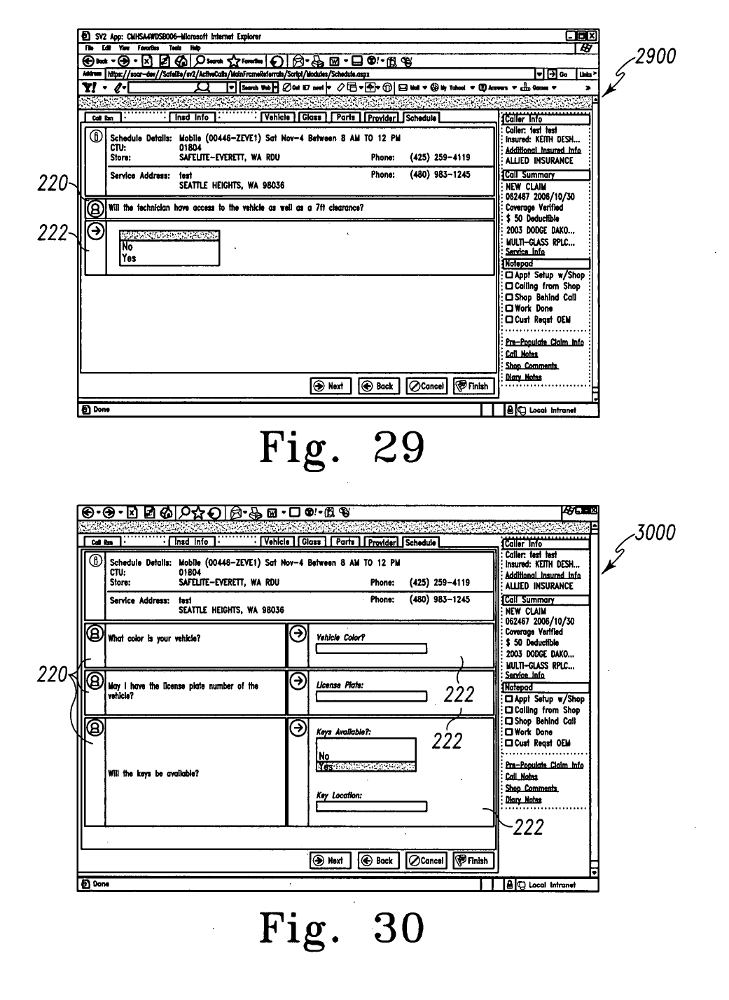

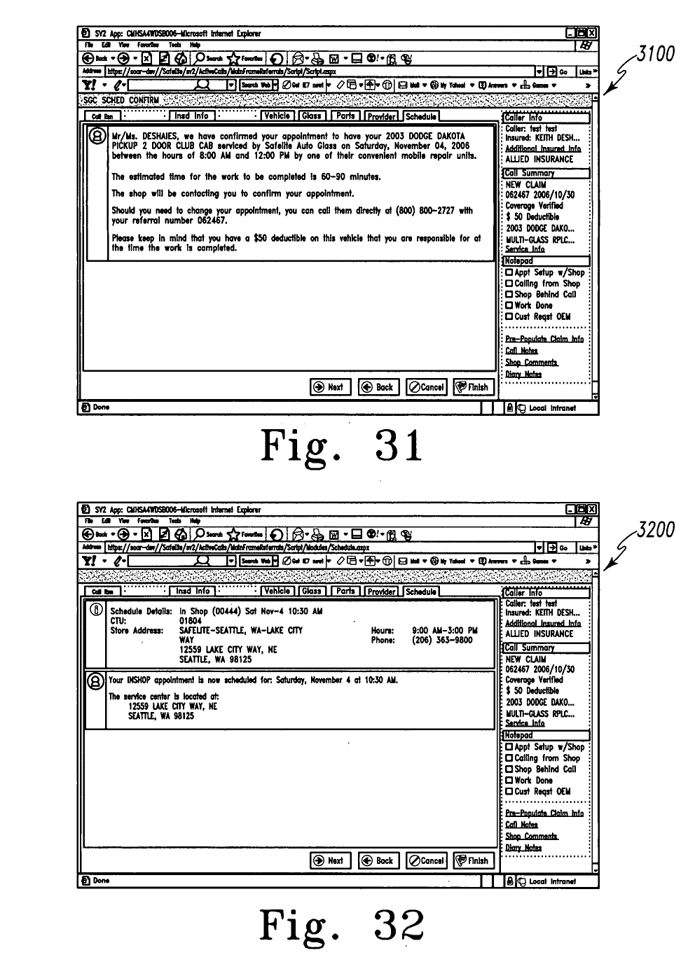

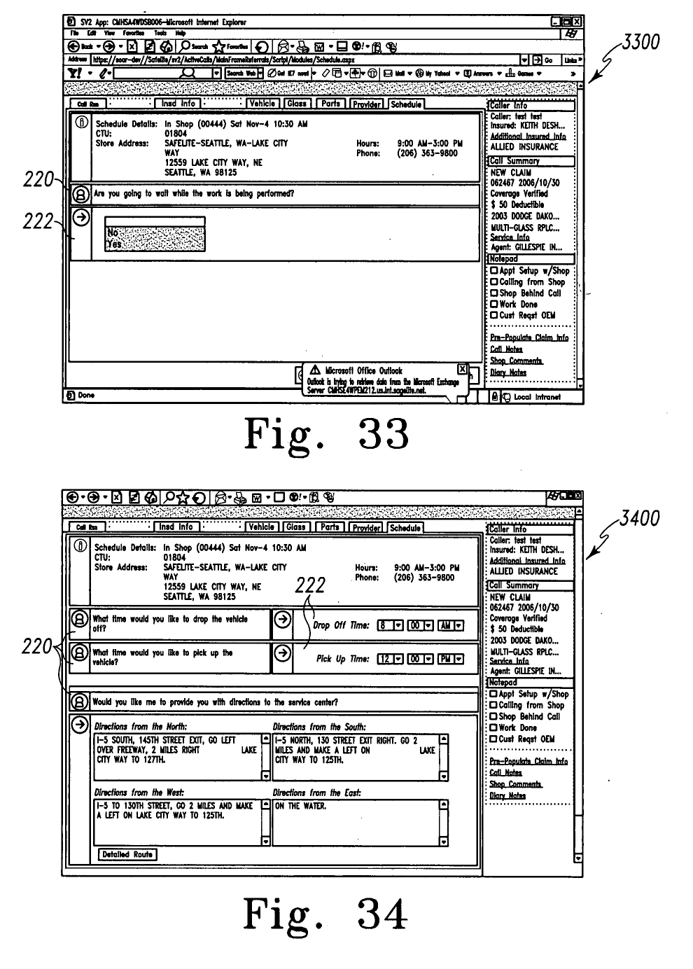

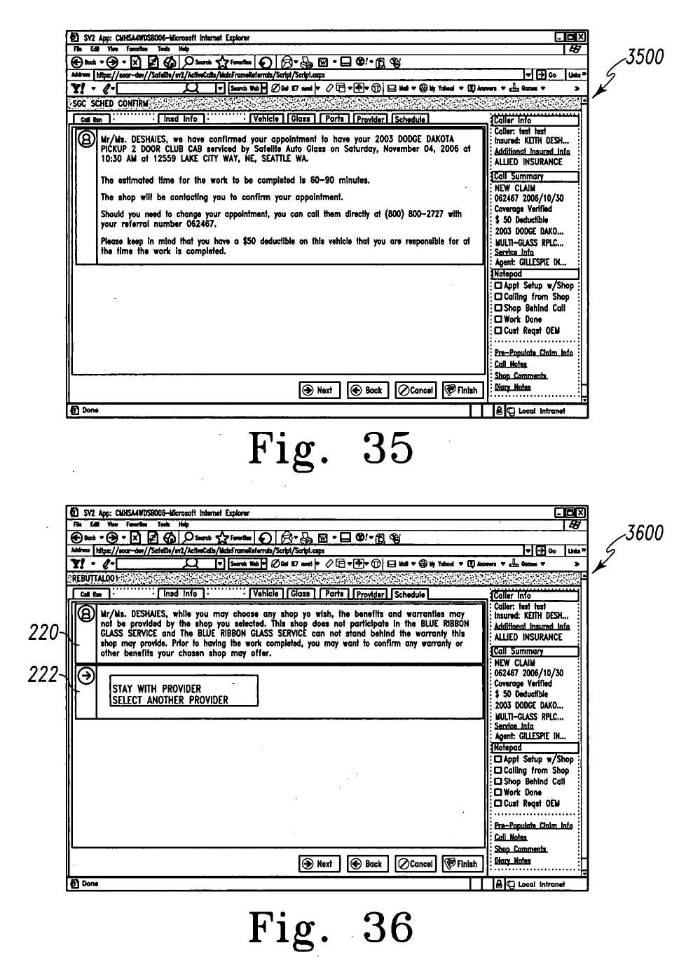

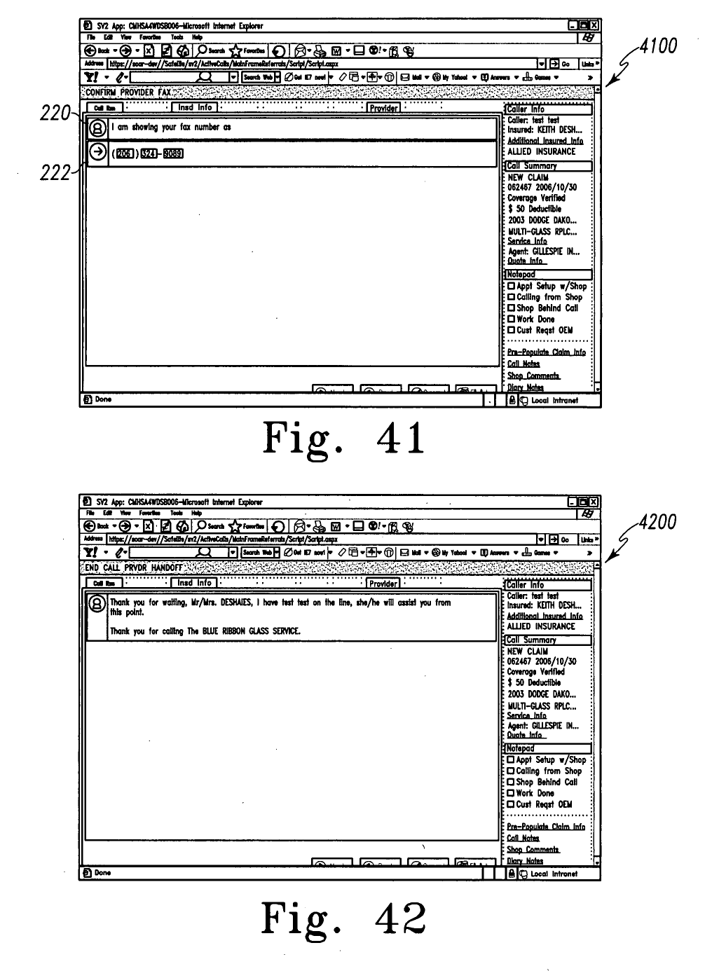

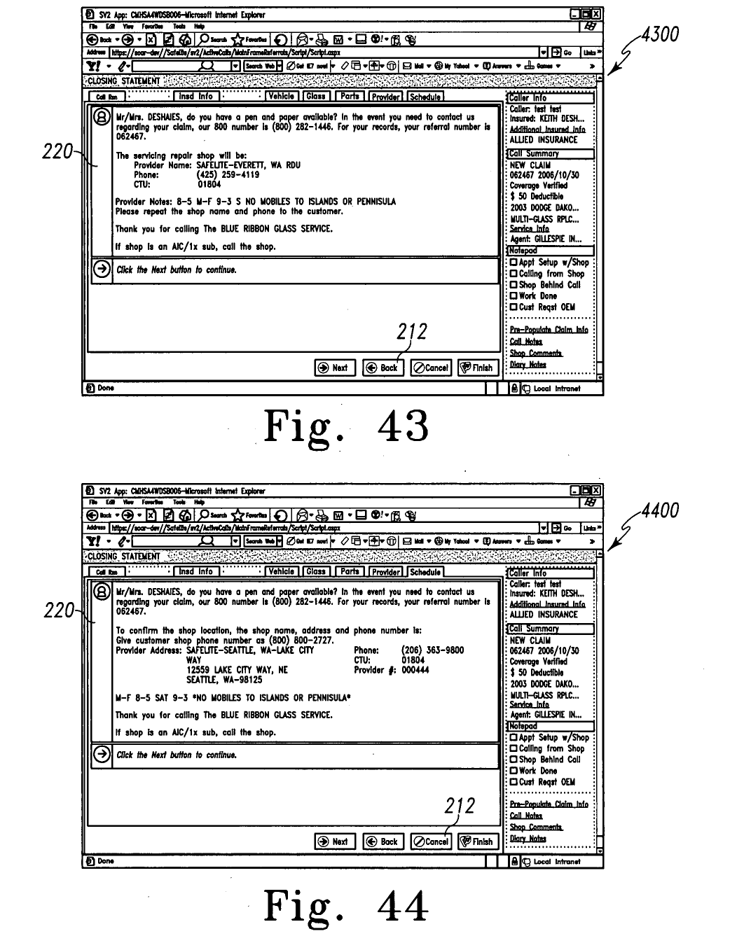

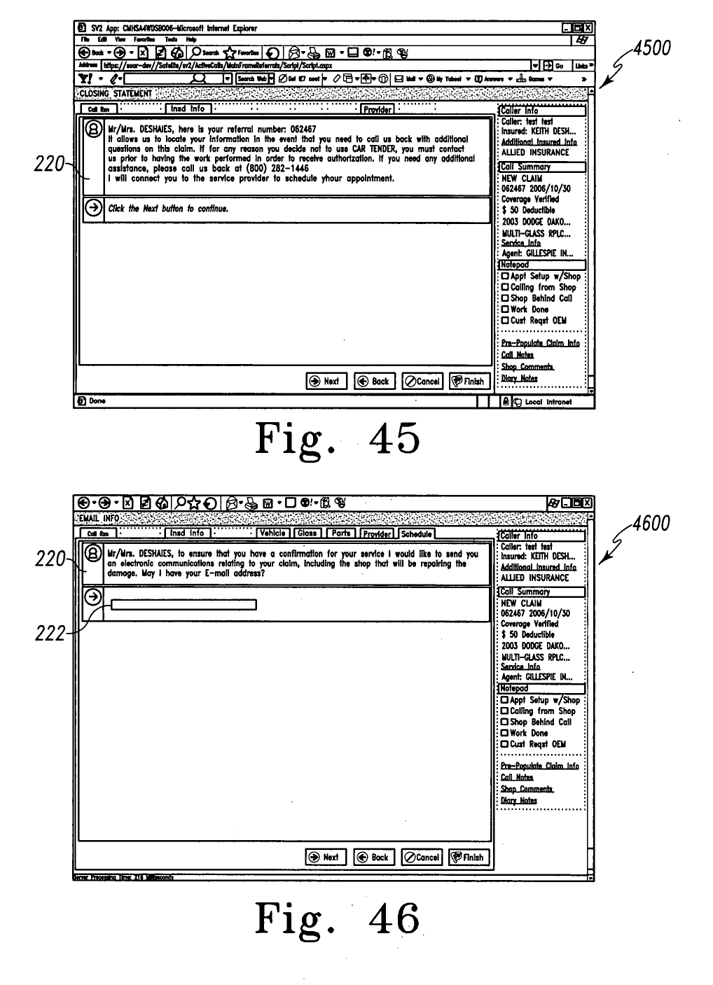

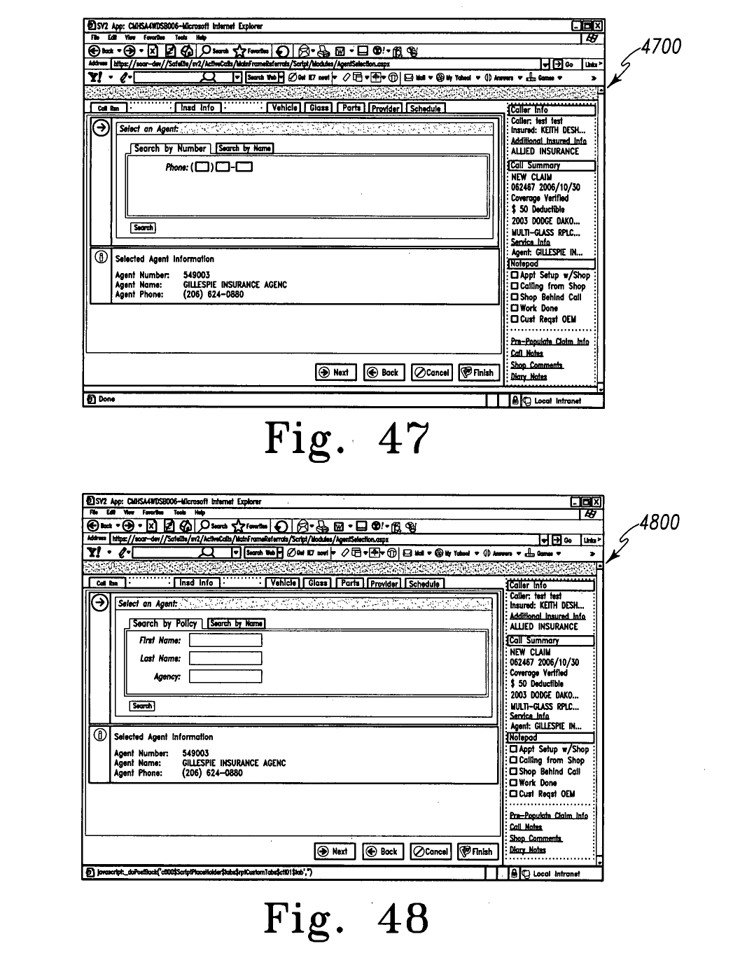

In one embodiment of the system architecture 200, the presentation tier 202 includes a user interface 208 that displays one or more of a plurality of script page 210 and custom user interface controls 212. Thus the presentation tier 202 acts as a user interface component of the system architecture 200 for processing service requests. Examples of graphical user interfaces 208 for presentation on a claim representative's computer device 5028 or a claimant's computer device 5326 are shown, for example, in FIGS. 3-48.

For certain insurance clients, the system may validate the formats for specific fields 222, to ensure that they are valid values for fields like insurance policy number and claim number as sub-processes of either the claim data collection module 120 or the coverage verification module 124. This validation may also be used to determine to which subsidiary of an insurance company client a policy may belong.

In one embodiment, a customer service representative 5020 interacting with the user interface 208 presented on a screen of computer device 5028 receives a service request from a claimant 5022 desiring to schedule service. Such service request may be received during face to face communication, during a telephone call between the service representative 5020 and the claimant 5022, via the internet or by any other means. In one embodiment, the service representative 5020 has access to a telephonic device 5024 and either initiates or receives a telephone call from a claimant 5022 utilizing a claimant telephonic device 5026 with the communication carried over a network 5036. In an alternative embodiment, the claimant 5022 may interact with a user interface similar to user interface 208 displayed on a network connected claimant computing device 5326 coupled to the server 5330 via a network 5034 to directly schedule service without the intervention of a service representative 5020. In all such cases the disclosed system architecture 200 operates in a similar manner and thus will be described only once with reference to the situation in which a claimant 5022 places a call to a service representative 5020 interacting with the system architecture 200 via the user interface 208 of a call center computer device 5028.

The call flow from beginning to end is called a script. Within a script are logical groups of information which are called script modules. Each script module may be utilized to carry out one of the operations or modified operations of the method 110 or modified method described herein. Each script module is made up of script pages 210. Each script page 210 includes call script text (typically presented in a script text frame 220 of a GUI, as shown for example in FIGS. 3-48) and controls (typically presented in a script control frame 222 of a GUI, as show, for example, in FIGS. 3-48) that enable the user to interact with the application. Custom UI controls are standard controls that were customized based on the facilitator's requirements. They are also used in the rendering of the GUI. These custom controls supplement the standard controls such as text box, dropdown, checkbox and others. Frame 222 shows the use of a standard control like a textbox to capture the first name, last name and zip code, and the use of a custom control like phone number where the control is displayed in (xxx)xxx-xxxx Ext. xxxxx format. In one embodiment, the script includes a claim data collection script module, a duplicate check script module, a coverage verification script module, a vehicle selection script module, a glass selection script module, a part selection script module, a coverage and features and benefits statement script module, a provider selection script module and a scheduling script module.

The claim data collection script module facilitates the capturing of claim information during the claim data collection operation 120 and or modifications to the claim data collection operation by presenting a GUI. The information captured during the claim data collection operation 120 may include, for example, claim number, policy number, insured name, insured address, loss date, and loss cause. Embodiments of the screens 300, 400, 500 by a GUI generated by script pages in the claim data collection script module, are shown, for example, in FIGS. 3-5. As shown, for example, in FIGS. 3-5 (and also in FIGS. 6-48), the script text presented in the script text frame 220 may include questions or statements to be presented to a claimant, either by a claim representative reading the scripts to the claimant during a telephone call or face to face meeting when using a system similar to system 5010 or by the claimant reading the script on the screen of their own computer device 5326 when using a system similar to system 5310. The controls in control frame 222 typically include controls for inputting information received which may include text boxes for receiving textual information entered by a claimant or a customer representative, radio buttons for selection by the claimant or representative, drop down lists from which claimants or representatives may select an appropriate response, pop up windows, etc. The GUI also utilizes custom controls 212 for navigating within and between modules. Illustratively, the custom controls 212 include a next button, a back button, a cancel button and a finish button, although more or fewer controls 212 may be presented.

As stated above, the script architecture 200 facilitates customization of the scripts as may be required by the insurance company client to be presented to a claimant. Thus, the screens of the GUIs shown in FIGS. 3-48 should be considered as only examples of the screens of the GUIs that may be presented for one specific insurance company client in an insured automotive glass loss scenario. GUIs for other insurance company clients in similar insured glass loss scenarios may produce screens that contain different textual content in the script text frame 220 as well as different controls in the control frame 222 and/or additional screens. Under different glass loss scenarios, more or fewer GUIs may be presented to carry out a method of facilitating repairs to insured items.

The duplicate check script module checks for possible duplicate claims based on the client duplicate search criteria facilitating the completion of the duplicate claim check operation 122 or modifications thereto by presenting a GUI. In the embodiment of screen 600 generated by the GUI generated by the duplicate claim check module illustrated in FIG. 6, the user (which may be the representative or claimant) is required to page through all the possible duplicates before allowing the user to proceed. In alternative embodiments, the user may be allowed to proceed with the method 110 without paging through all possible duplicate claims, may be presented with a listing of possible duplicate claims in a single window with the ability to bore down further into claims identified as possible duplicates, or may be presented with possible duplicate claims in a different fashion. As shown, for example, in FIG. 6, the controls frame 222 may be superimposed over the script text frame in appropriate situations within the scope of the disclosure.

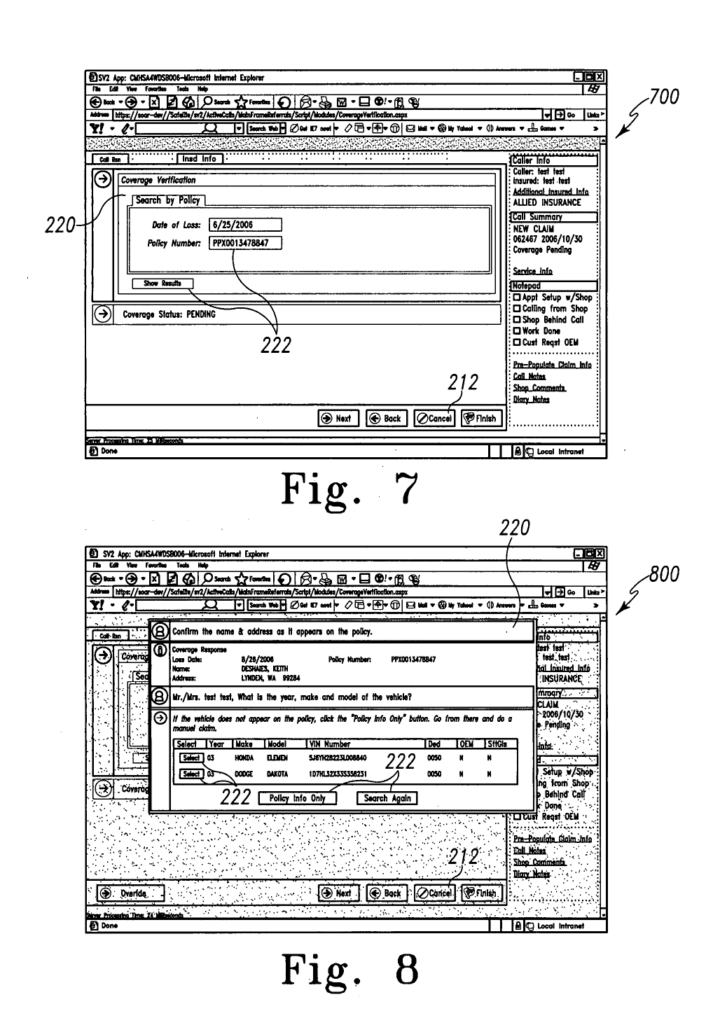

The coverage verification script module performs an external call to retrieve coverage data required to complete the coverage verification operation 124 or modifications thereto by presenting screens generated by a GUI. This external call may be performed by placing a telephone call over a telecommunications network 5036 between a call center telephone 5024 and an insurance clients telephone 5048 wherein the client representative 5020 converses with an insurance representative 5050 who utilizes a client computer or terminal 5046 to access the insurance database 5044 to acquire the necessary information to validate coverage. The necessary information may be communicated orally during the telephone call or may be communicated electronically via a computer network 5034 from the insurance companies computer system 5042 to the call center web server 5030 for incorporation into a GUI displayed on the computer 5028 accessed by the representative 5020. Alternatively, this call may be an electronic communication over a computer network 5034 whereby the appropriate insurance client's database 5044 is accessed to acquire the data to verify coverage which data is communicated electronically via the network 5034 through the web server 5030 for display in a GUI on the representative's computer 5028 or a claimant's computer 5326, as appropriate. The search may be based on loss date, policy number, insured name, or insured zip and other criteria the client specifies. The GUI screen 700 illustrated in FIG. 7, shows an example wherein the coverage is verified by searching by policy number. FIG. 8 shows an example of a GUI screen 800 that may be presented if the policy was found. The resulting information is displayed to the user.

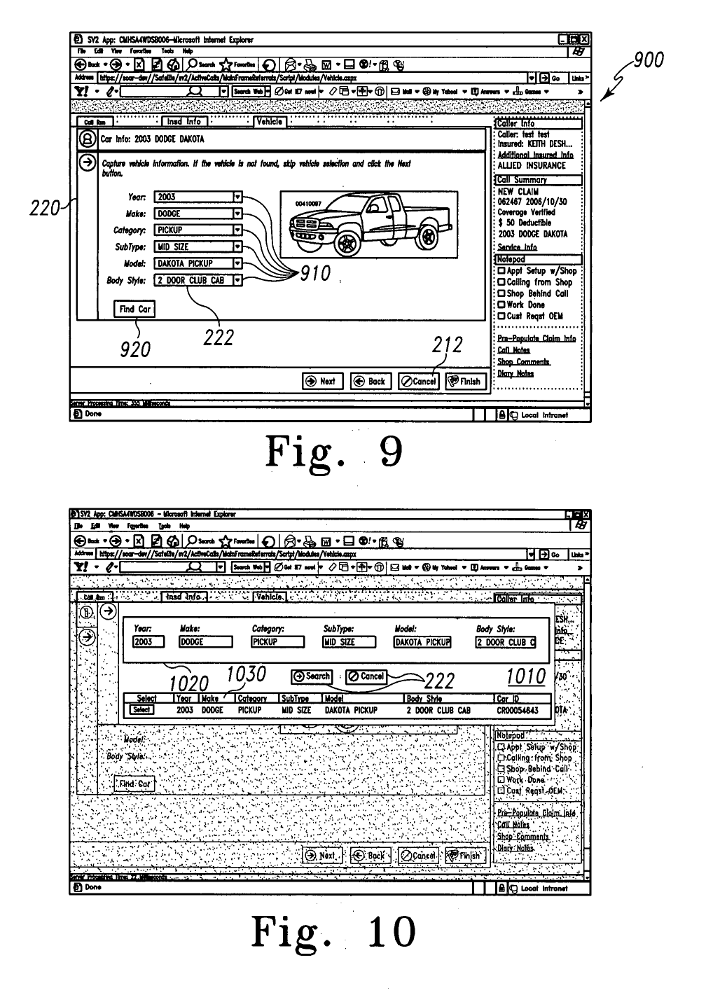

The vehicle selection module generates a GUI that facilitates the capturing of the vehicle information in the vehicle selection operation 126 or modifications thereto. Such information may include the year, make, category, subtype, model, body style and/or vehicle identification number. As shown, for example, in FIG. 9, the GUI screen 900 generated by the vehicle selection module may appear under a tab labeled vehicle. Multiple tabs are shown in the screen shots of the GUIs shown in FIGS. 3-48. These tabs provide an alternate control for navigating between different screens and modules. The embodiment of the GUI generated by the vehicle selection module shown in FIG. 9 provides the user with the option of either selecting the vehicle details from a plurality of dropdown lists 910 or using the Find Car button 920. Activating the Find Car button 920 causes a pop-up search screen 1010 to be presented which includes a search criteria frame 1020 wherein the user can enter search criteria and a search results frame 1030 that presents a list of search results from which the user can select the appropriate vehicle, as shown, for example, in FIG. 10.

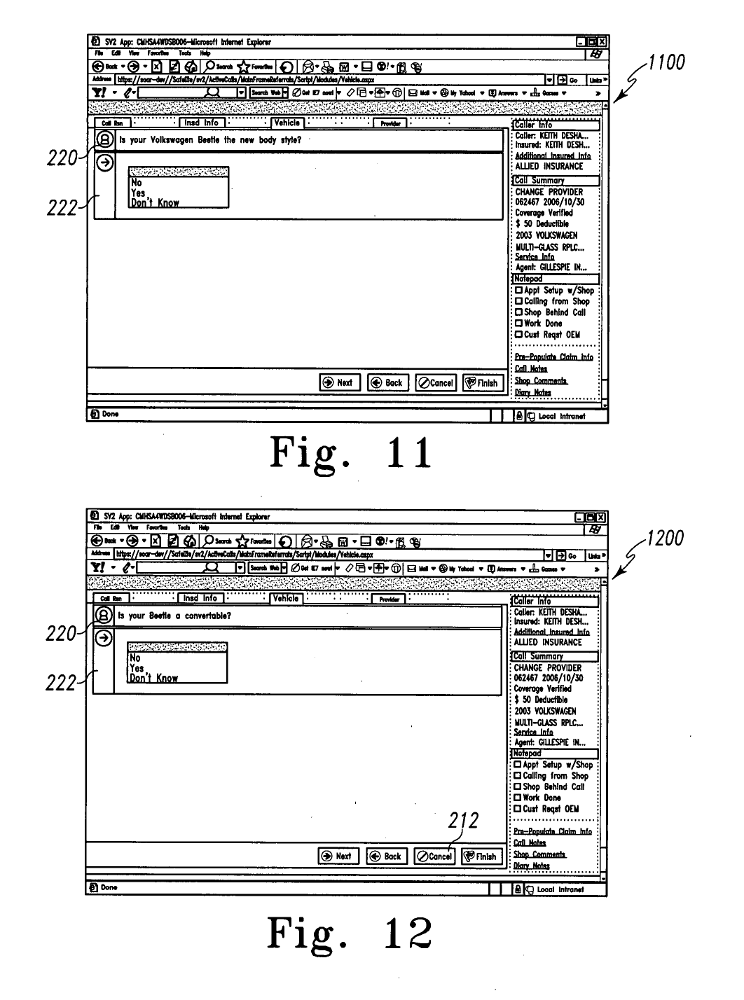

The vehicle selection operation 126, glass selection operation 128 and/or part selection operation 130 may be modified or the method 110 may be modified by adding an additional operation to address “problem vehicles” by implementing a vehicle exception process that as shown, for example, in FIG. 51. The vehicle exception process generates a GUI which may have multiple screens 1100 and 1200, as shown, for example, in FIGS. 11 and 12. The illustrated GUI screens are presented as an exception process in vehicle selection module when a “problem vehicle” has been identified. If there is a possible ambiguity as to the type of the vehicle selected, the user may be asked a series of questions to determine the exact vehicle.

An example of a problem vehicle would be a 2003 Volkswagen Beetle. In order to ensure that the correct glass and or parts are selected for a 2003 Volkswagen Beetle, it is necessary to clarify whether the customer has the New Beetle. As shown, for example, in FIG. 11, the GUI screen's 1100 script text frame 220 includes the question “Is your Volkswagen Beetle the new body style?” It is within the scope of the disclosure for the text frame 220 to include other questions and for the question format to be dictated by each insurance company client.

The script control frame 222 illustratively includes a drop down list providing the selections “No, Yes” and “Don't Know.” The user can interact with the script control frame 222 to indicate the answer to the question presented in the script text frame 220, in the illustrated embodiment by double clicking or otherwise selecting one of the presented answers. Depending on the user's response, the scripting engine generates another screen. While the illustrated script controls frame 222 includes a selectable list, it is within the scope of the disclosure for the script control frame 222 to include other widgets, such as, for example, a drop down-list, a text box, a plurality of radio buttons etc., permitting the user to indicate their answer to the query in the script text frame 220.

In the illustrated example, if the user answers ‘No’ or ‘Don't Know’, then the vehicle would be the old Beetle model causing the scripting engine to generate a glass selection module and a parts selection module appropriate to the old Beetle body style. If the answer is ‘Yes’ , then the vehicle would be the new Beetle model, which, in the illustrated embodiment causes the scripting engine to generate a screen 1200 similar to that shown in FIG. 12. New model 2003 Beetles can be either a convertible or a hatchback. Thus, as shown in FIG. 12 the script text frame off the generated GUI screen 1200 includes the question “Is your Beetle a convertible?” The script control frame 222 in the illustrated embodiment again includes a drop down list providing the selections “No, Yes” and “Don't Know.” The user can interact with the script control frame 222 to indicate the answer to the question presented in the script text frame 220, in the illustrated embodiment by double clicking or otherwise selecting one of the presented answers. Depending on the user's response, the scripting engine then either generates module appropriate for a 2003 new model Beetle convertible or hatchback during the glass selection and part selection operations. While the illustrated script controls frame 222 includes a selectable list, it is within the scope of the disclosure for the script control frame 222 to include other widgets, such as, for example, a drop down-list, a text box, a plurality of radio buttons etc., permitting the user to indicate their answer to the query in the script text frame 220.

The glass selection module is generated by the script architecture 200 to facilitate completion of the glass selection operation 128 and produces a GUI having one or more screens appropriate to the vehicle selected in vehicle selection step 126. The screen 1300 presented by the GUI illustrated in FIG. 13 includes a script text frame 220 including the text “Which Piece of glass was damaged?” Again the content of the script text frame 220 in the screen 1300 of the GUI generated by the glass selection module can be customized according to the insurance company client's wishes. Since a 2003 2 door Dodge Dakota Pickup truck with a club cab was selected in the screen 900, a picture of that vehicle truck is shown in FIG. 13. The script control frame 222 of screen 1300 includes a selectable list of glass components appropriate for the vehicle selected in the vehicle selection module. Again, the script control frame can utilize other widgets to facilitate selection of the damaged glass within the scope of the disclosure. The user's selection of a glass component controls the GUI generated by the scripting engine in the parts selection module.

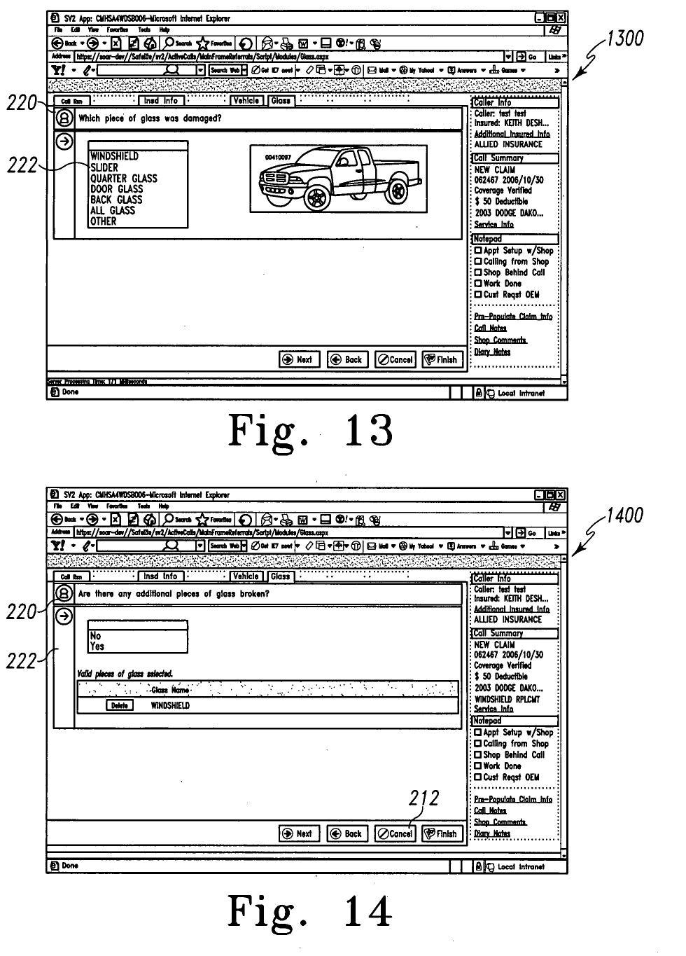

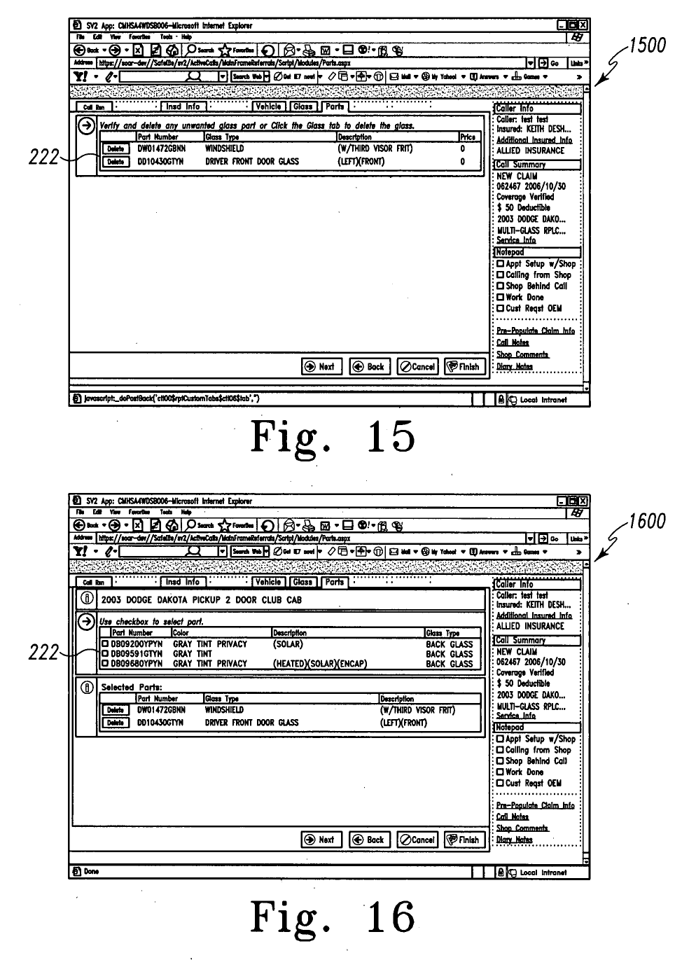

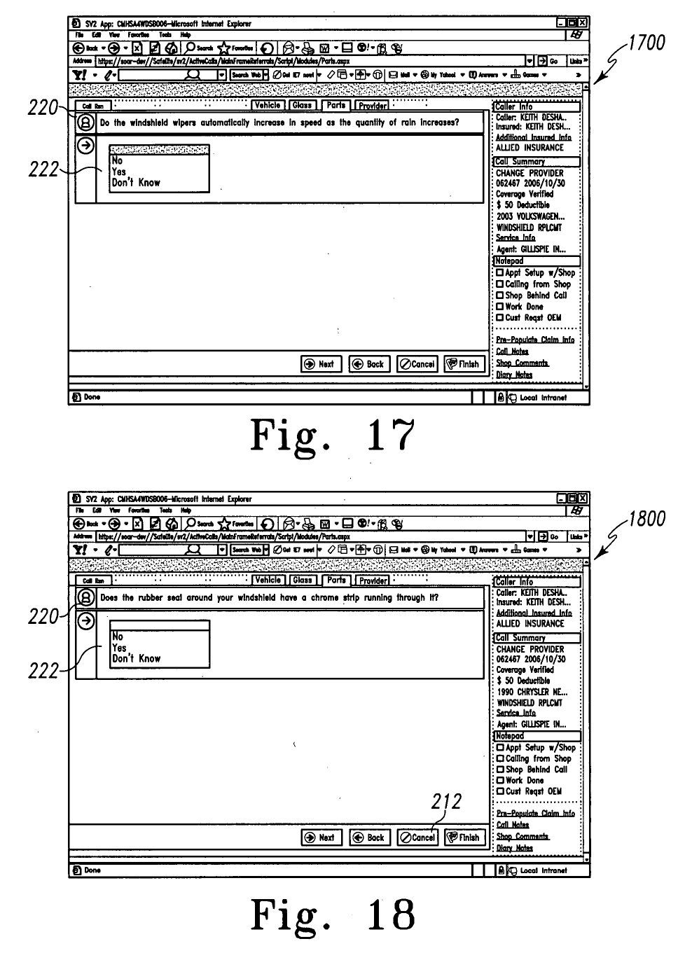

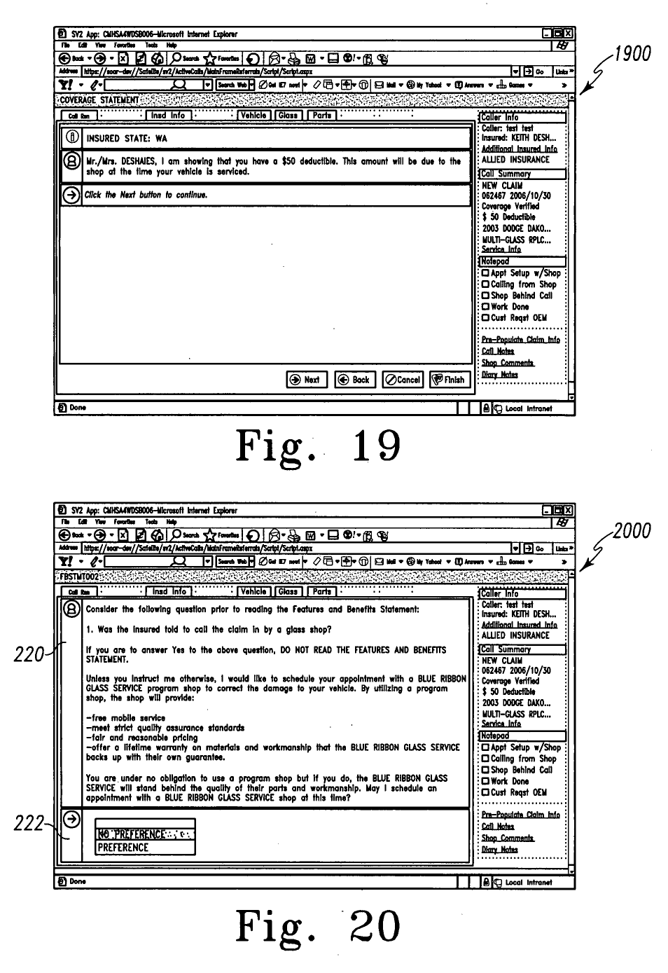

As shown, for example, in FIG. 14, once a user has selected a piece of glass that has been damaged, the GUI may present a screen 1400 for determining if other pieces of glass have been damaged. The screen 1400 generated by the GUI that may follow the selection of a damaged piece of glass may include a script text frame 220 including the question “Are there any additional pieces of glass broken?” or a similar question regarding additional glass damage. In the illustrated screen 1400, the script control frame 222 includes a selectable list from which the options “Yes” and “no” may be selected. Other widgets may be presented for indicating whether additional glass was damaged. If the answer is “yes” then the engine returns to generate a screen similar to screen 1300. In some embodiments, previously identified damaged glass will not be selectable in this screen. When the answer is no, or at any other time while screen 1400 is being displayed, the user can delete any previously selected glass by selecting a delete button associated with the glass to be deleted, as show, for example, in FIG. 14.

Based on the vehicle selected during the vehicle selection operation and the glass selected during the glass selection operation, the engine then initiates the parts selection module that generates one or more screens of the GUI as appropriate that facilitate the parts selection operation 130 and is appropriate for the identified vehicle and identified glass damage. The engine may loop through the screens shown in FIG. 16, as appropriate, for each piece of damaged glass. The parts selection module allows the user to select the part for the selected piece(s) of glass or modifications thereto by presenting a GUI.

If there is only one active orderable part for the glass, the application auto picks the part for the user and displays a screen 1500 of a GUI indicating the appropriate available parts. The user can again delete any of these parts by selecting the delete button in the script control frame 222 associated with the unwanted part.

If more than a single option is available for a damaged piece of glass, the application presents a GUI screen 1600 with a parts list displayed and associated controls to allow selection of each displayed part in the script control frame 222. The illustrated controls include check boxes to select the appropriate window tint for the selected damaged glass. By checking the boxes the user can select the appropriate part.

There is an exception process in part selection called problem glass and problem molding. If there is a possible ambiguity as to the type of glass selected, the user may be asked a series of questions to determine the exact glass type before the part can be selected.

An example would be the windshield on the 2003 Volkswagen New Beetle 2 Door Convertible. There is rain sensor feature on this piece of glass so the application needs to know if the windshield has one or not in order to select the correct part. In the exception process for the 2003 Beetle the application generates a GUI having screen 1700. In the script text frame 220 the query “Do the windshield wipers automatically increase in speed as the quantity of rain increases.” Other queries will be presented for other vehicles having problem glass components which queries will help to select the appropriate glass for repairing the damaged vehicle.

The script control frame 222 illustratively includes a drop down list providing the selections “No, Yes” and “Don't Know.” The user can interact with the script control frame 222 to indicate the answer to the question presented in the script text frame 220, in the illustrated embodiment by double clicking or otherwise selecting one of the presented answers. Depending on the user's response, the scripting engine generates another screen. While the illustrated script controls frame 222 includes a selectable list, it is within the scope of the disclosure for the script control frame 222 to include other widgets, such as, for example, a drop down-list, a text box, a plurality of radio buttons etc., permitting the user to indicate their answer to the query in the script text frame 220.

If moldings come with the part and there is ambiguity with the type of molding that is needed for the part, the application generates a part molding exception process with a GUI screen 1800 wherein the user may be asked a series of questions to clarify the type of molding. In the illustrated example of a screen 1800 generated for the molding on the windshield for a 1990 Chrysler New Yorker 4 Door Sedan, the script text frame 220 includes the query ” Does the rubber seal around your windshield have a chrome strip running through it?” For this vehicle, this the answer to this query would aid in the selection of the appropriate molding for the damaged glass. The part molding exception process for other vehicles would generate similar screens with appropriate queries to facilitate part selection.

The script control frame 222 illustratively includes a drop down list providing the selections “No, Yes” and “Don't Know.” The user can interact with the script control frame 222 to indicate the answer to the question presented in the script text frame 220, in the illustrated embodiment by double clicking or otherwise selecting one of the presented answers. Depending on the user's response, the scripting engine generates another screen. While the illustrated script controls frame 222 includes a selectable list, it is within the scope of the disclosure for the script control frame 222 to include other widgets, such as, for example, a drop down-list, a text box, a plurality of radio buttons etc., permitting the user to indicate their answer to the query in the script text frame 220.

The Coverage and Features and Benefits Statement module generates one or more GUI screens, such as screens 1900 and 2000 that contain the script that the user reads to the customer. The illustrated screen 1900 contains text in the script text frame 220 that explains the coverage and features and benefits. The coverage and features and benefits module may generate different screens with different script text frame content that reflect the desires of each individual insurance client. FIG. 20 depicts a GUI screen 2000 that includes a script text frame 220 asking for the customer provider preference and a script control frame 222 including a selectable list from which the claimant's desire may be selected.

The provider selection module generates GUI screens that facilitate the completion of the provider selection operation 132 that allow the user to select the provider based on customer preference. Preferences may include service type (mobile vs. in-shop) and service location.

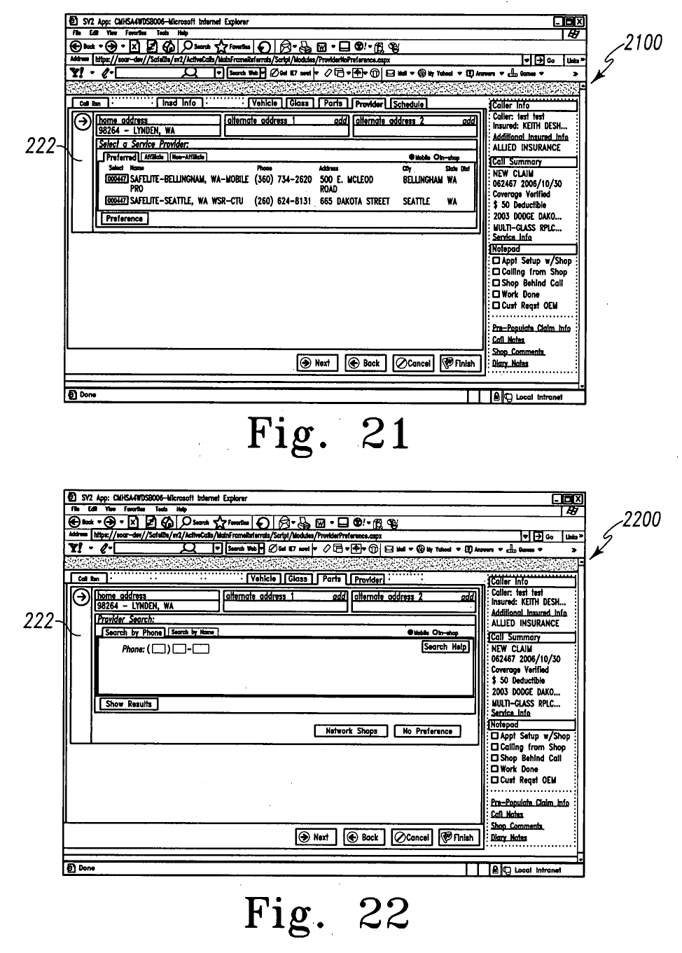

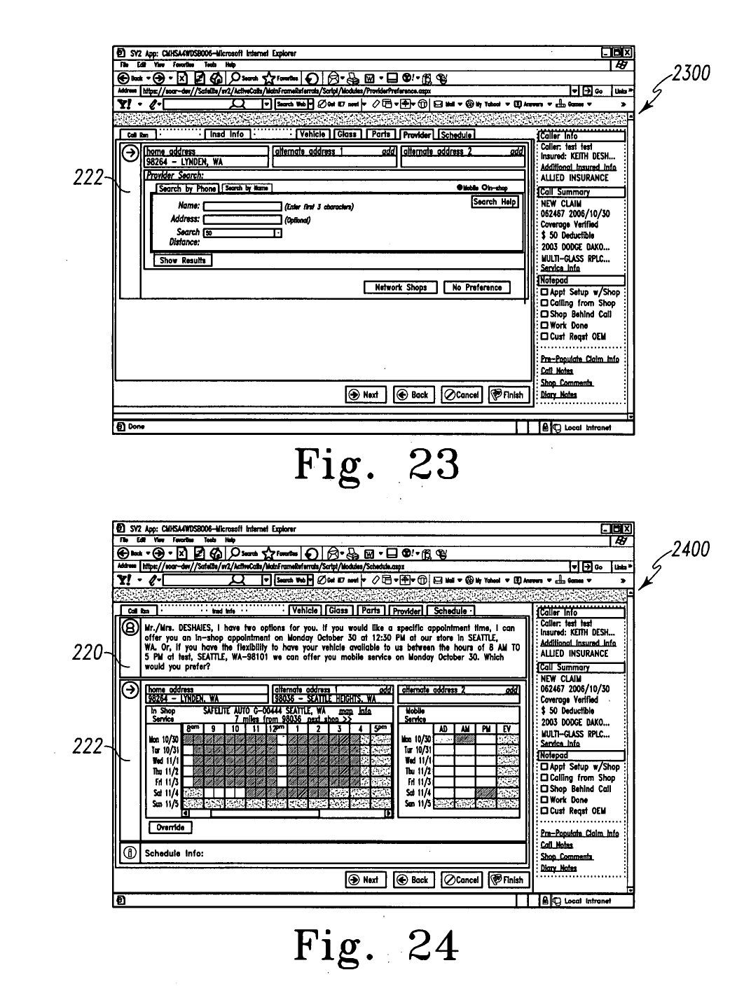

In one embodiment of the provider selection module, if the customer has no provider preference, the user may be presented with a GUI screen, an example of which is screen 2100, shown, for example, in FIG. 21, that includes a provider list that is grouped based on client affiliation. Screen 2100 includes a script control frame 222 that alternatively allows the selection of one of the affiliated provides or an indication that the claimant has a provider preference. If the claimant has a provider preference, the user is presented with a provider search page. In one embodiment, the provider selection module generates a GUI screen, an example of which is shown in FIG. 22 as screen 2200, wherein the user can search for a provider by telephone number. The script control frame 222 of screen 2200 includes text boxes for entry of a telephone number that may utilized to search the database 5032 resident at the call center or a provider database 5064 on a computer system 5066 accessible via the network 5034. Alternatively, the telephone number may be used to place a call to the provider coupling the client representative telephonic device 5024 to a provider telephonic device 5062 via network 5036. In another embodiment, the provider selection module generates a GUI screen, an example of which is shown in FIG. 23 as screen 2300, wherein the user can search for a provider by name and address. The script control frame 222 of screen 2300 includes text boxes for entry of a name and/or address that is utilized to search a database 5032 including provider information.

The scheduling module generates GUI screens that allow the user to schedule an appointment with a provider thereby facilitating the scheduling operational 34. Such scheduling may be at a facilitator associated shop, a provider approved by an insurance company client, and/or a provider preferred by the claimant based on customer preference. Similar to provider selection, preferences include service type and service location.

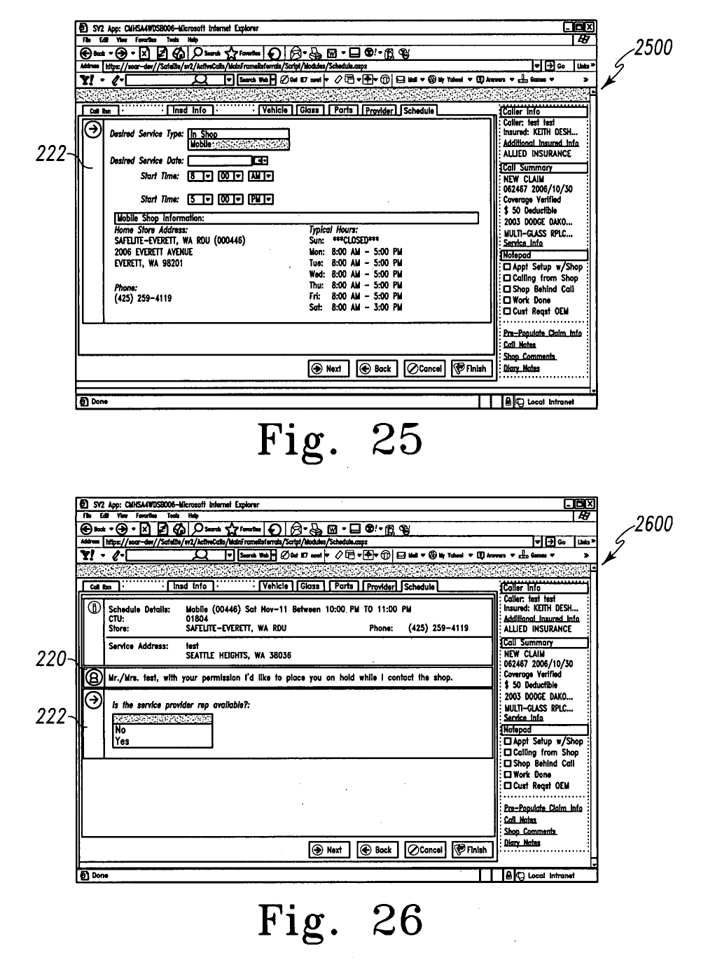

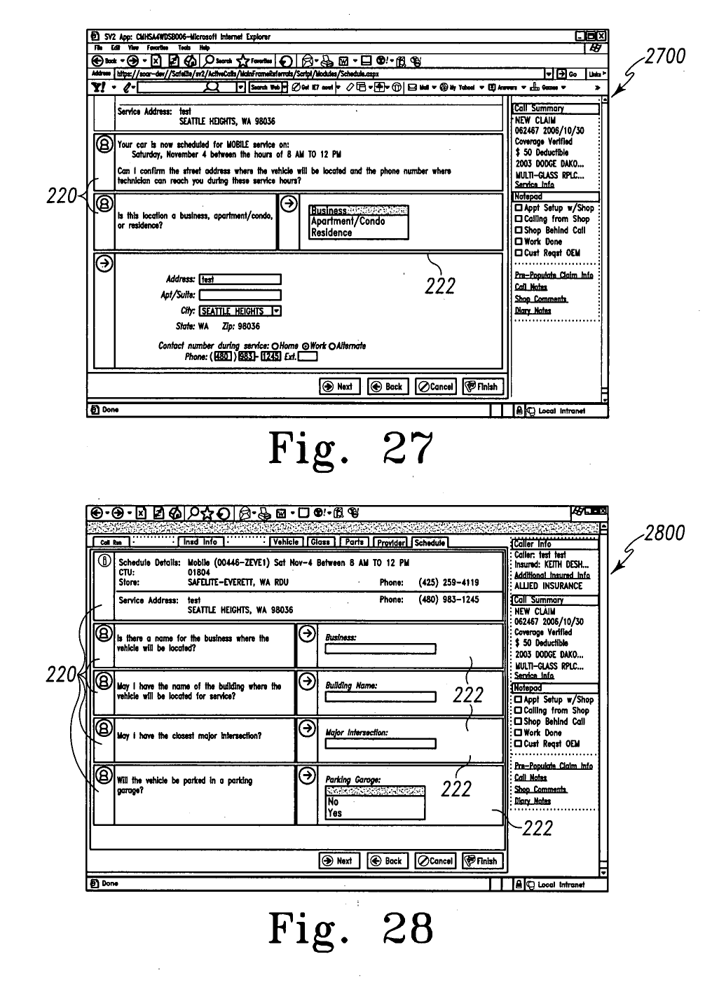

As shown, for example, in FIG. 24, according to one embodiment, when available, the application generates a GUI screen 2400 wherein the user is presented with both in-shop and mobile appointment options for the next 7 days, illustratively displayed as text and tables in the script control frame 222. In the illustrated embodiment, the schedules are for facilitator associated in-shop and mobile repair services. Thus, the appointment availability is determined by accessing the database 5052 which stores such information. The script text frame 220 includes text that explains the available options to the claimant. If the preferred appointment is not shown as an option, the user can use the Override button 2410 in the script control frame 222.

Actuating the override button 2410 causes the scheduling module to generate a GUI screen 2500, as shown, for example, in FIG. 25, containing a script control frame 222 with text boxes that allows the user to specify the customer's preferred appointment.

If the appointment cannot be scheduled, the scheduling module generates a GUI screen 2600, as shown, for example, in FIG. 26, that allows the user to contact the shop to negotiate the appointment date and time. This contact may be via a call using the call center telephonic device 5024 which connects a call via the network 5036 with a provider telephonic device 5062 manned by a provider representative 5068 having access to the provider database 5064 via a provider representative computer or terminal 5070. If the appointment can be scheduled, the user will be allowed to proceed and confirm the details of the appointment.

As shown, for example, in FIGS. 27-30, the scheduling module may generate GUI screens similar to the illustrated screens 2700, 2800, 2900 and 3000 that include screen text frames 220 containing appropriate text and script control frames 222 for providing scheduling details for a mobile service.

GUI screens, such as screens 3100, 3200, 3300, 3400 and 3500 shown as examples, are generated by the scheduling module after a schedule is arranged to provide the client with information regarding the scheduled appointment and the option to select another appointment.

If the customer provider preference is a non-affiliate or non-network shop, and the insurance company client requires a pricing agreement, the offer and acceptance module generates GUI screens that guide the user through the offer and acceptance operation 136 by providing an appropriate offer and acceptance script according to the client's preference.

As, shown, for example, in FIG. 36, offer and acceptance module generates a GUI screen 3600 that presents a rebuttal page that contains text in the script text frame 220 that explains to the customer the benefits and guarantees of the selected provider. The script control frame 222 presents a list from which the claimant's desire to stay with the selected provider or choose a new provider can be indicated.

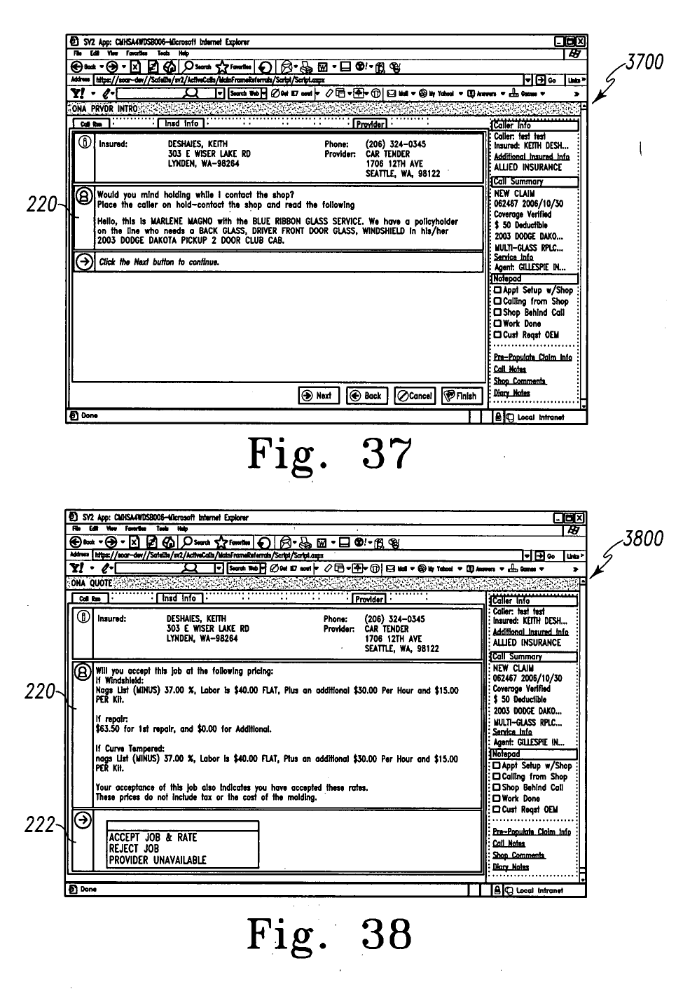

As, shown, for example, in FIG. 37-38, if the claimant chooses to stay with the selected provider, the offer and acceptance module generates GUI screens, such as screens 3700, 3800 shown as examples, that provide script text to be utilized by the user in contacting the provider to acquire a pricing agreement.

If the user accepts pricing, the offer and acceptance module generates a GUI screen, such as screen 3900 shown as examples, whereby the user can proceed to assign the job. As shown, for example, in FIG. 39, if the user rejects pricing or provider cannot be contacted but the customer wants to stay with the provider, the user informs the customer of what the client is willing to pay. If the customer agrees, the user can proceed and assign the job.

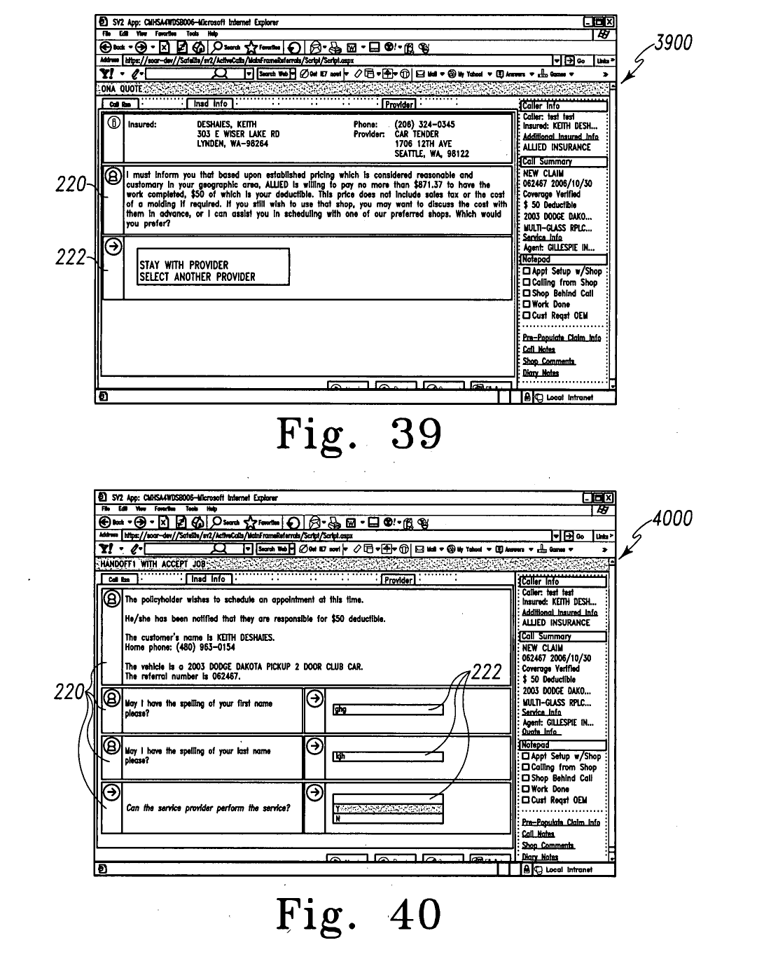

As shown, for example, in FIG. 40-42, the provider hand-off module generates GUI screens, such as screens 4000, 4100, 4200 shown as examples, if needed, to enable the user to connect the customer to the provider selected and also to confirm provider fax.

As shown, for example, in FIGS. 43-45, the closing statement module generates GUI screens, such as screens 4300, 4400, 4500 shown as examples that provide the call summary information. The provider information on the call summary varies based on the provider and service selected. FIG. 43 is an example of a closing statement 4300 for a facilitator In-Shop schedule. FIG. 44 is an example of a closing statement 4400 for a facilitator mobile schedule. FIG. 45 is an example of a final closing statement 4500 for a facilitator schedule.

Depending on the client requirement, the application can send an email notification to the customer regarding their appointment. The engine can cause the GUI to generate a screen, as shown, for example in FIG. 46 that provides a script and controls for acquiring and entering an e-mail address from the claimant.

Depending on the client requirement, the application can enable agent selection. The user may search for the appropriate agent either by telephone, as shown, for example in FIG. 47, or by name, as shown, for example, in FIG. 48

Returning to the description of the architecture 200, the data tier 204 includes the business and data access components of the application. Business entities are used to pass information between the two components. The business components evaluate the business process rules and execute logic while the data access components retrieve and update data in the database.

Errors encountered when executing the business logic or data access logic are thrown back to the calling web page and handled from there.

The script driver 206 is a business component that serves as the central processing component of the call flow application. The script driver 206 handles several functions. At script start, the script driver 206 determines which script page to display as the first page by calling the scripting engine 212 as shown in FIG. 2. The script driver 206 manages user navigation action (next button, back button, cancel button, finish button, module tabs) and displays the appropriate script page also using the scripting engine 212. On occurrence of a next page event, the script driver 206 calls the edits driver 216 to execute any validation logic on the page controls 222 and processes the results accordingly. On occurrence of a next page event, the script driver 206 also calls the subsidiary driver 214 to execute any client subsidiary logic and processes the results accordingly. On occurrence of a next module event, the script driver 206 calls to the business component to update data in the database. If the page to be displayed is a dynamic page, the script driver passes script object data to the script page 210 in order to render the page correctly. At script finish, the script driver 206 executes final edits and processing and makes a call to the outbound interface which sends the record to an external application.

The subsidiary driver 214 is the business component that executes the subsidiary logic. It checks for the subsidiary flag on the page control and if it is enabled, it executes the appropriate logic. An example of a control is policy number. There are clients that assign policy number formats that are unique to each of its subsidiaries. Based on this format, the user may be switched to a different call path.

The edit driver 216 is the business component that performs edits on the controls on the page. The edits could be any of the following: mask validation; date validation; list validation; valid value validation or other appropriate validation to facilitate a method being accomplished. The result of the edits is returned to the script driver. If there are any errors, the script driver displays an error message to the user.

The scripting engine 212 is the data access component that populates the script object business entities. The data is used by the script driver to perform functions related to user navigation and dynamic rendering of script pages. In certain embodiments of the disclosed systems, methods and user interfaces, each insurance client 5040 is assigned an account number. Each account will have a script associated with it. The script is made up of modules. The script has to have starting point so one of modules needs to be flagged as the starting module for the script. The modules will have pages. The starting module in a script has to have a starting page. The call flow will start with the starting page of the starting module of the script.

Scripting has two types of modules, static and dynamic. Static modules have preset pages and functions that are enabled across all clients. Its functionality is in the code behind the static module web page and is not overseen by the scripting engine. Dynamic modules are those that are flexible in terms of the pages and the information contained in each page.

For dynamic pages, the page details such as controls, control display order, control attributes, etc. are retrieved from the database in order to display the page correctly. Static modules will each be represented by its starting page in the scripting table. The rendering of the page is within the web page for the static module. On page transition of dynamic pages, business rule and logic, if any, are executed and the next page of the call flow is determined by the branching rule. The same process applies when transitioning from a static module to a dynamic page. The call flow ends when there is no next page or next module to branch to.

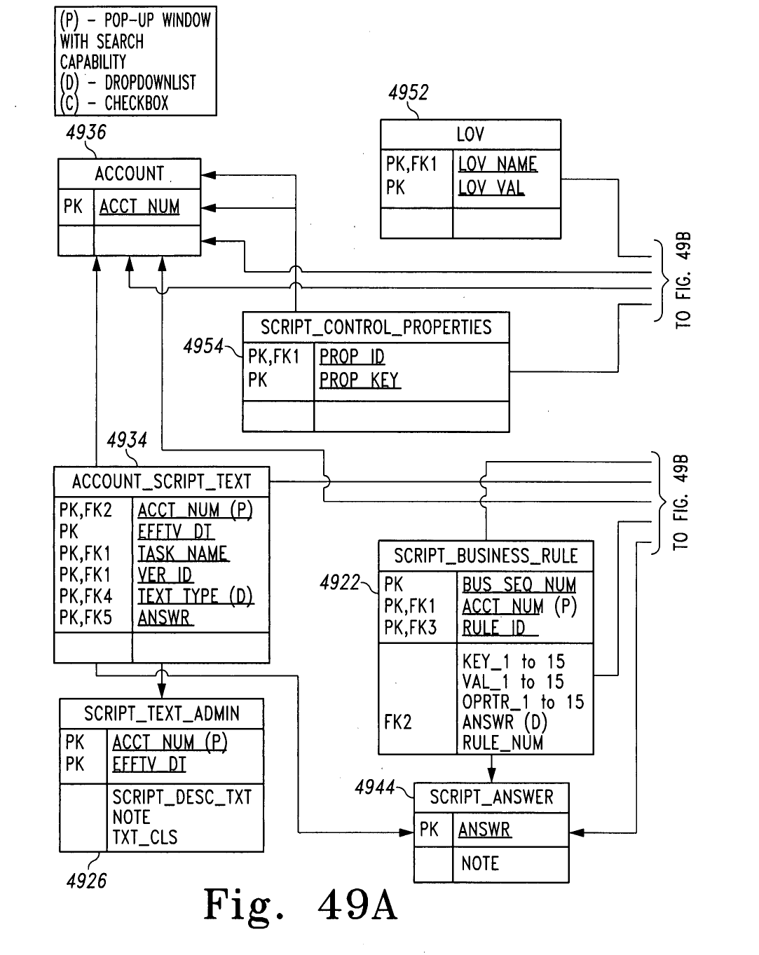

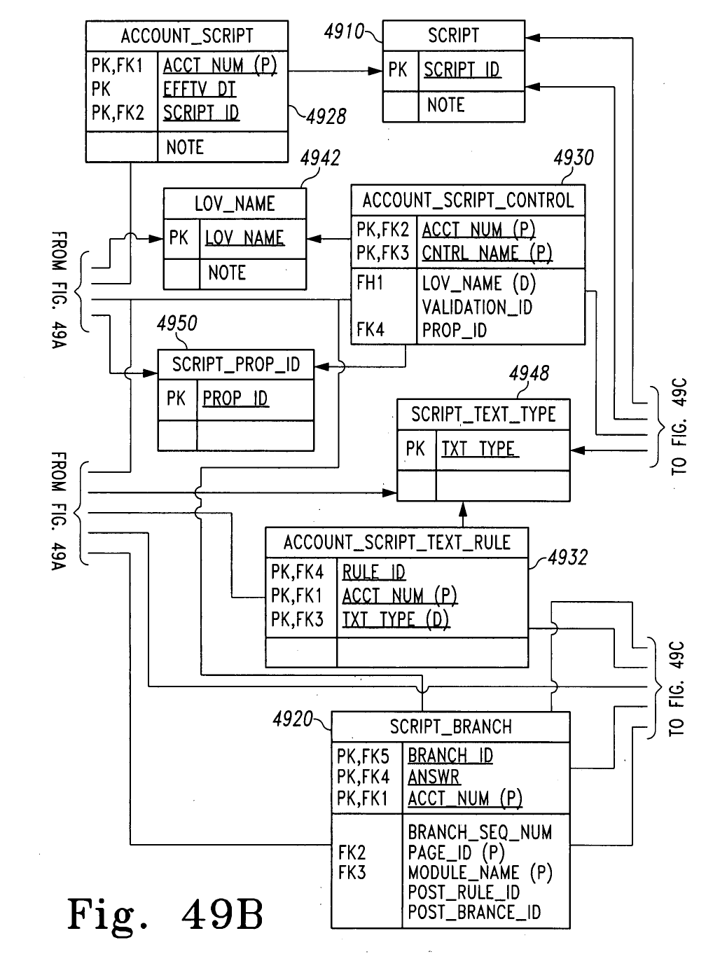

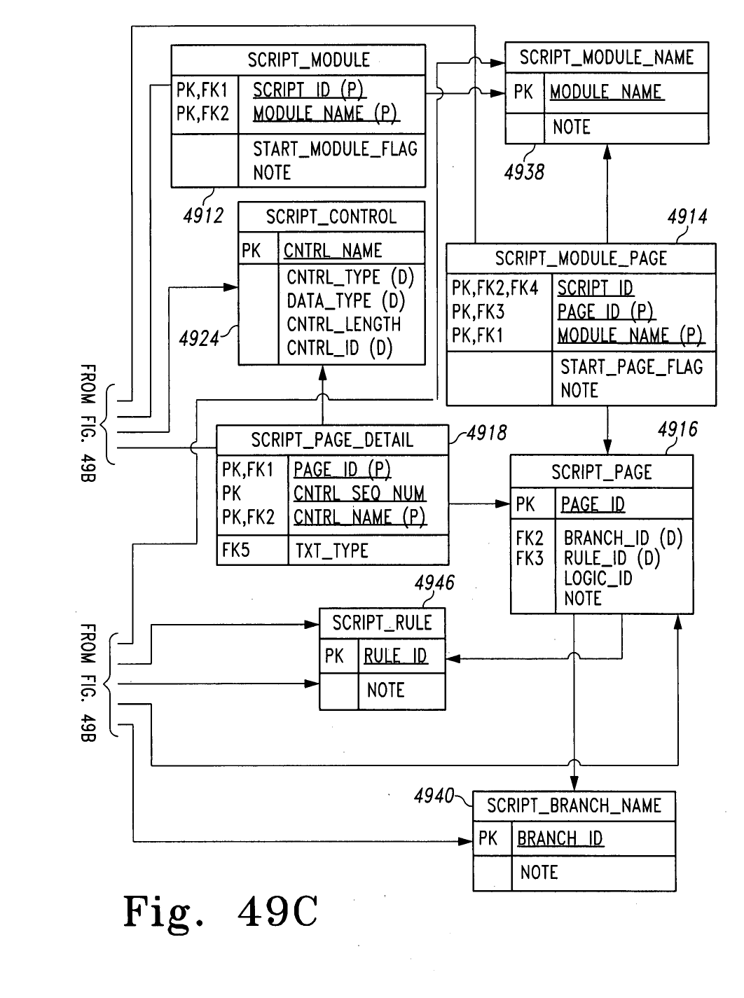

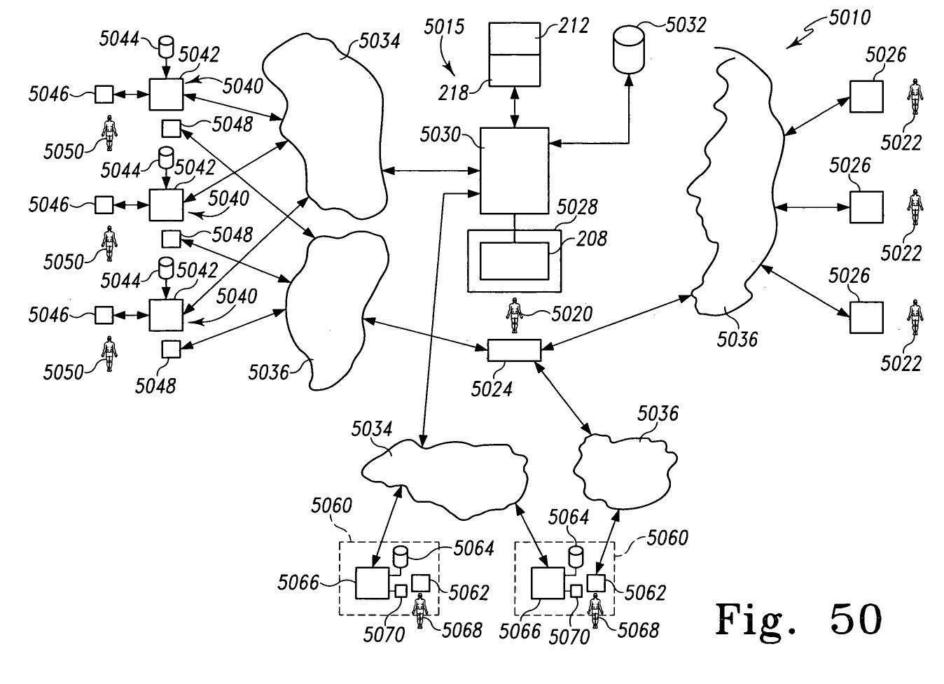

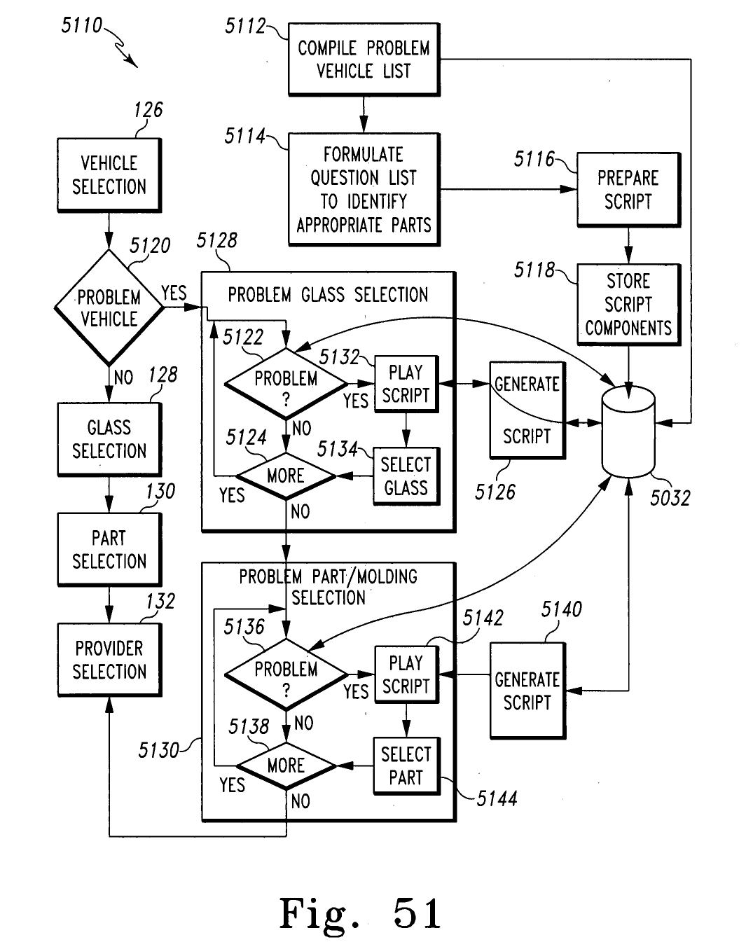

One example of a scripting engine data model, is shown, for example, in FIG. 49. The scripting tables 4900 includes SCRIPT data structure 4910, SCRIPT_MODULE data structure 4912, SCRIPT_MODULE_PAGE data structure 4914, SCRIPT_PAGE data structure 4916, SCRIPT_PAGE_DETAIL data structure 4918, SCRIPT_BRANCH data structure 4920, SCRIPT_BUSINESS_RULE data structure 4922; SCRIPT_CONTROL data structure 4924; SCRIPT_TEXT_ADMIN data structure 4926; ACCOUNT_SCRIPT data structure 4928, ACCOUNT_SCRIPT_CONTROL data structure 4930, ACCOUNT_SCRIPT_TEXT_RULE data structure 4932, ACCOUNT_SCRIPT_TEXT data structure 4934, ACCOUNT referential table 4936, SCRIPT_MODULE_NAME referential table 4938, SCRIPT_BRANCH_NAME referential table 4940, LOV_NAME referential table 4942, SCRIPT_ANSWER referential table 4944, SCRIPT_RULE referential table 4946, SCRIPT_TEXT_TYPE referential table 4948, SCRIPT_PROP_ID referential table 4950, and LOV data structure 4952.

The SCRIPT data structure 4910 stores script Ids utilizing the SCRIPT_ID object that represent a unique script flow. The SCRIPT data structure 4910 is linked to the SCRIPT_MODULE_PAGE data structure 4914, the SCRIPT_MODULE data structure 4912 and the ACCOUNT_SCRIPT data structure 4928.

The SCRIPT_MODULE data structure 4912 specifies the starting module for a given script Id utilizing the SCRIPT_ID object and the MODULE_NAME object. The SCRIPT_MODULE data structure 4912 is linked to the SCRIPT data structure 4910 and the SCRIPT_MODULE_NAME referential table 4938.

The SCRIPT_MODULE_PAGE data structure 4914 contains data specifying the starting page for a given module utilizing the PAGE_ID object, the SCRIPT_ID object and the MODULE_NAME object. The SCRIPT_MODULE_PAGE data structure 4914 is linked to the SCRIPT_PAGE data structure 4916, the SCRIPT data structure 4910 and the SCRIPT_MODULE_NAME referential table 4938.

The SCRIPT_PAGE data structure 4916 stores data relating to page information utilizing the PAGE_ID object, BRANCH_ID, RULE_ID and LOGIC_ID objects that apply to the page. The SCRIPT_PAGE data structure 4916 is linked to the SCRIPT_PAGE_DETAIL 4918, SCRIPT_MODULE_PAGE 4914 and SCRIPT_BRANCH 4920 data structures and to the SCRIPT_BRANCH_NAME 4940, SCRIPT_MODULE_NAME 4938 and SCRIPT_RULE 4946 referential tables.

The SCRIPT_PAGE_DETAIL data structure 4918 stores page details to be rendered to the user such as the control(s) utilizing the CNTRL_SEQ_NUM, CONTROL_NAME, and TXT_TYPE objects and the script text(s) utilizing the PAGE_ID object. The SCRIPT_PAGE_DETAIL data structure 4918 is linked to the SCRIPT_CONTROL data structure 4924, SCRIPT_TEXT_TYPE 4948 referential table and the SCRIPT_PAGE data structure 4916.

The SCRIPT_BRANCH data structure 4920 stores or accesses client-specific branching information that indicates where the script will go next utilizing the BRANCH_ID object, ANSWR object and the ACCT_NUM object as well as the BRANCH_SEQ_NUM, NEXT_PAGE_ID and NEXT_MODULE_NAME objects. The SCRIPT_BRANCH data structure 4920 is linked to the SCRIPT_PAGE data structure 4916 and the ACCOUNT 4936, SCRIPT_ANSWER 4944, SCRIPT_BRANCH_NAME 4940 and SCRIPT_MODULE_NAME 4938 referential tables.

The SCRIPT_BUSINESS_RULE data structure 4922 stores client-specific business rule information that determines different branching and script text options utilizing the BUS_SEQ_NUM object, the ACCT_NUM object and the RULE_ID object. The SCRIPT_BUSINESS_RULE data structure 4922 is linked to the ACCOUNT 4936, SCRIPT_ANSWER 4944 and the SCRIPT_RULE 4946 referential tables.

The SCRIPT_CONTROL data structure 4924 stores control detail information such as control type, data type, id and length utilizing the CNTRL_NAME, CNTRL_TYPE, CNTRL_DATA_TYPE, CNTRL_LENGTH and CNTRL_ID objects. The SCRIPT_CONTROL data structure 4924 is linked to the ACCOUNT_SCRIPT_CONTROL 4930 and SCRIPT_PAGE_DETAIL 4918 data structures.

The SCRIPT_TEXT_ADMIN data structure 4926 stores versions of script text and actual text for script controls and other scripting requirements utilizing the TASK_NAME, VER_ID and TXT_CLS objects. The SCRIPT_TEXT_ADMIN data structure 4926 is linked to the ACCOUNT_SCRIPT_TEXT data structure 4934.

The ACCOUNT_SCRIPT data structure 4928 stores data regarding the Script Id for a client utilizing ACCT_NUM and SCRIPT_ID and EFFTV_DT objects. A generic script is assigned to a default parent account, which will be used by clients following the generic script flow. The ACCOUNT_SCRIPT data structure 4928 is linked to the ACCOUNT referential table 4936 and the SCRIPT data structure 4910.

The ACCOUNT_SCRIPT_CONTROL data structure 4930 stores client specific control detail information such as list of values, property Id and validation rules utilizing ACCT_NUM, CNTRL_NAME, VALIDATION_ID, PROP_ID and LOV_NAME objects. The ACCOUNT_SCRIPT_CONTROL data structure 4930 is linked to the SCRIPT_CONTROL data structure 4924 and the LOV_NAME 4942, ACCOUNT 4936 and SCRIPT_PROP_ID 4950 referential tables.

The SCRIPT_CONTROL_PROPERTIES data structure 4954 stores control property information such as read-only, default value, required, expression validation and other control properties utilizing PROP_ID object. The SCRIPT_CONTROL_PROPERTIES data structure 4954 is linked to the SCRIPT_PROP_ID 4950 referential table.

The LOV data structure 4952 stores list of values information such as display value, lookup value, display order and other list information utilizing LOV_NAME object. The LOV data structure 4952 is linked to the LOV_NAME 4942 referential table.

The ACCOUNT_SCRIPT_TEXT_RULE data structure 4932 stores client-specific rules to be applied to the script text type utilizing the ACCT_NUM and TXT_TYPE objects. ACCOUNT_SCRIPT_TEXT_RULE data structure 4932 is linked to the ACCOUNT 4936, SCRIPT_TEXT_TYPE 4948 and SCRIPT_RULE 4946 referential tables.

The ACCOUNT_SCRIPT_TEXT data structure 4934 stores client-specific script text information that identifies the script text version rendered on the page utilizing the ACCT_NUM, TASK_NAME, VER_ID, TXT_TYPE and ANSWR objects. The ACCOUNT_SCRIPT_TEXT data structure 4934 is linked to the ACCOUNT 4936 and SCRIPT_TEXT_TYPE 4948 referential tables and the SCRIPT_TEXT_ADMIN data structure.

The ACCOUNT referential table 4936 stores account information utilizing the ACCT_NUM object. The ACCOUNT referential table 4936 is linked to the ACCOUNT_SCRIPT 4928, ACCOUNT_SCRIPT_CONTROL 4930, SCRIPT_BRANCH 4920, ACCOUNT_SCRIPT_TEXT_RULE 4932, SCRIPT_BUSINESS_RULE 4922 and ACCOUNT_SCRIPT TEXT 4934 data structures.

The SCRIPT_MODULE_NAME referential table 4938 stores various module name utilizing the MODULE_NAME object. The SCRIPT_MODULE_NAME referential table 4938 is linked to the SCRIPT_MODULE 4912, SCRIPT_MODULE_PAGE 4914 and SCRIPT_BRANCH 4920 data structures.

The SCRIPT_BRANCH_NAME referential table 4940 stores branch names utilizing BRANCH_ID objects. The SCRIPT_BRANCH_NAME referential table 4940 is linked to the SCRIPT_PAGE 4916 and the SCRIPT_BRANCH 4920 data structures.

The LOV_NAME referential table 4942 stores list of value names utilizing LOV_NAME object. The LOV_NAME referential table 4942 is linked to the ACCOUNT_SCRIPT_CONTROL data structure 4930.

The SCRIPT_ANSWER referential table 4944 stores potential branches followed according to the script answer utilizing the ANSWR object. The SCRIPT_ANSWER referential table 4944 is linked to the SCRIPT_BRANCH 4920, ACCOUNT_SCRIPT_TEXT 4934 and the SCRIPT_BUSINESS_RULE 4922 data structures.

The SCRIPT_RULE referential table 4946 stores scripting rules utilizing the RULE_ID object. The SCRIPT_RULE referential table 4946 is linked to the SCRIPT_PAGE 4916 and SCRIPT_BUSINESS_RULE 4922 data structures.

The SCRIPT_TEXT_TYPE referential table 4948.stores the text types utilizing TXT_TYPE object. The SCRIPT_TEXT_TYPE referential table 4948 is linked to the SCRIPT_PAGE_DETAIL 4918, ACCOUNT_SCRIPT_TEXT_RULE 4932 and ACCOUNT_SCRIPT_TEXT 4934 data structures.

The SCRIPT_PROP_ID referential table 4950 stores the property Ids utilizing PROP_ID object. The SCRIPT_PROP_ID referential table 4950 is linked to the ACCOUNT_SCRIPT_CONTROL 4930 and SCRIPT_CONTROL_PROPERTIES 4954 data structures.

The call script business component retrieves the appropriate script text for the given control on the page using the GetCallScriptText method. It calls several methods in both the business component and data access component layers to get the actual text displayed to the user.

Systems 5010 and 5310 which facilitate repairs of insured items have been described in detail through the specification. System 5010 illustrates a system wherein a claimant calls a customer service representative of the call center who is presented with the various GUI screens generated by the various modules described herein as an aid in collecting information from the client, the claimant and providers. System 5310 illustrates a system whereby the claimant directly accesses the call center computer system and is guided by GUI screens presented by the various modules disclosed herein to contact the insurance client and providers. Not all GUI screens described herein may be accessible to claimants utilizing system 5310. Additionally, it is within the scope of the disclosure for components of system 5010 and 5310 to be combined and for additional or fewer components to be included in the disclosed or combined systems. Computer devices and systems disclosed may include various computing devices such as servers, mainframes, laptop computer, personal computers, personal data assistants and other devices within the scope of the disclosure. Such computing devices may contain the necessary memory components required to carry out the functions described herein and to store computer readable software required for such functions The disclosed databases may be onsite data bases implemented in the memory of the described computer systems, in separate database servers either onsite or available through a network. Telephonic devices may be a device capable of transmitting and receiving oral communications such as land based telephones, cellular telephones, voice over internet devices, radios, mobile telephones etc. The illustrated networks may be any network appropriate for the communication of the devices disclosed such as the internet or other computer networks, POTS, cellular communication networks, microwave networks, etc.

While the present invention has been described in detail with reference to certain exemplary embodiments thereof, such are offered by way of non-limiting example of the invention, as other versions are possible. Moreover, a number of design choices exist within the scope of the present invention, some of which have been discussed above. It is anticipated that a variety of other modifications and changes will be apparent to those having ordinary skill in the art and that such modifications and changes are intended to be encompassed within the spirit and scope of the invention as defined by the following claims.

What is claimed is:

1. A method for facilitating automotive glass repair and/or replacement comprising:
receiving from a claimant a request to arrange for repair and/or replacement of damaged automotive glass;
generating, utilizing a scripting engine running on a computer device, a graphical user interface for display on a screen of a computer device;
displaying the generated graphical user interface on a screen of a computer device;
interacting with the graphical user interface to arrange for repair and/or replacement of the damaged automotive glass.

2. The method of claim 1 wherein the claimant holds a policy with an insurance company against which policy the claimant wishes to make a claim for repair and/or replacement of the damaged automotive glass and further comprising:
receiving a script from the insurance company setting forth queries to be made when a claim is made against an insurance policy issued by the insurance company; and
storing in memory accessible by the computer device on which the scripting engine is running a portion of the received script;
wherein the generating step includes accessing the memory to retrieve the stored portion of the received script and the displaying step includes displaying the retrieved stored portion of the script in the graphical user interface.

3. The method of claim 2 and further comprising tendering an insurance payment as cash.

4. The method of claim 2 wherein the policy held by the claimant includes an original equipment manufacturer endorsement and further comprising arranging with a service provider to have the repair and/or replacement of the damaged automotive glass of the claimant to be performed with original equipment manufacturer parts.

5. The method of claim 1 and further comprising automatically selecting a service provider to perform the requested automotive glass repair and/or replacement when the claimant has no preference for a specific service provider.

6. The method of claim 1 and further comprising obtaining a current schedule for available appointments of multiple service providers wherein the displaying step includes displaying the schedules of the available appointments for the multiple service providers and further comprising utilizing the displayed schedules to arrange an appointment to conduct the requested automotive glass damage repair and/or replacement with one of the multiple service providers.

7. The method of claim 6 and further comprising notifying the claimant via electronic mail of the arranged appointment.

8. The method of claim 6 and further comprising scheduling an appointment to conduct the requested automotive glass damage repair and/or replacement with a service provider other than one of the multiple service providers.

9. The method of claim 1 further comprising:
creating a database in memory accessible by the computer device running the scripting engine, the database including identification data for a plurality of vehicle models that have different versions of glass for different vehicle configurations and glass identifying data regarding each version of glass for each such vehicle configuration;
developing a glass identification script for each vehicle model in the database each such glass identifying script being stored in memory accessible to the computer device running the scripting engine, being linked to the identification data for the vehicle model to which it relates and being crafted to elicit answers that identify an appropriate version of glass to replace automotive glass damage of a claimant; and
collecting information from a claimant to identify the vehicle model for which a request to arrange for repair and/or replacement of damaged automotive glass has been made;
wherein displaying the generated graphical user interface includes displaying the appropriate developed glass identification script when the collected information indicates that the vehicle model is a vehicle model for which identification data is stored in the database.

10. The method of claim 1 and further comprising offering to replace the windshield wiper blades at the time the requested automotive glass damage is repaired or replaced.

11. The method of claim 1 wherein the computer system running the scripting engine is accessible by a customer representative having access to a telephonic device, the received request is received over the telephonic device and the displayed graphical user interface is displayed on the screen of a computer device with which the customer representative interfaces.

12. The method of claim 1 wherein the received request is received via a network coupling a claimant computer device to the computer device running the scripting engine and the displayed graphical user interface is displayed on a screen of the claimant computer device.

13. A user interface for facilitating automotive glass repair and/or replacement comprising:
a graphical display for displaying on a computer output device, the graphical display including a plurality of screens including a script text frame for presenting script text facilitating acquisition from a claimant of appropriate information required to arrange for repair and/or replacement of damaged automotive glass and a script control frame including controls to indicate the acquired information and to control plurality of screens displayed on the computer device; and
an input device for interacting with the script control frame of the plurality of screens.

14. The user interface of claim 13 for utilization in arranging repair and/or replacement of damaged automotive glass of a claimant that holds an insurance policy with an insurance company against which policy the claimant wishes to make a claim for repair and/or replacement of the damaged automotive glass and wherein the script text frame of one of the plurality of screens includes text of a portion of a script received from the insurance company setting forth queries to be made when a claim is made against an insurance policy issued by the insurance company.

15. The user interface of claim 14 wherein one of the plurality of screens includes text in the script text frame indicating that an insurance payment may be tendered as a cash payment to the claimant.

16. The user interface of claim 14 wherein the policy held by the claimant includes an original equipment manufacturer endorsement and wherein one of the plurality of screens includes text in the script text frame utilized for arranging with a service provider to have the repair and/or replacement of the damaged automotive glass of the claimant to be performed with original equipment manufacturer parts.

17. The user interface of claim 13 wherein one of the plurality of screens includes text in the script text frame to facilitate automatically selecting a service provider to perform the requested automotive glass repair and/or replacement when the claimant has no preference for a specific service provider.

18. The user interface of claim 13 wherein one of the plurality of screens includes text of a current schedule for available appointments of multiple service providers.

19. The user interface of claim 18 wherein one of the plurality of screens includes text in the script text frame to facilitate scheduling an appointment to conduct the requested automotive glass damage repair and/or replacement with a service provider other than one of the multiple service providers.

20. The user interface of claim 13 wherein one of the plurality of screens includes text in the script text frame to facilitate identification of an appropriate automotive glass component for a vehicle model that has different versions of glass for different vehicle configurations.

21. The user interface of claim 13 wherein one of the plurality of screens includes text in the script text frame to facilitate automatically selecting a service provider to perform the requested automotive glass repair and/or replacement when the claimant has no preference for a specific service provider.

22. The user interface of claim 13 wherein one of the plurality of screens includes text in the script text frame to facilitate offering to replace the windshield wiper blades at the time the requested automotive glass damage is repaired or replaced.

23. The user interface of claim 13 wherein the graphical display is displayed on a computer screen accessible by a customer representative having access to a telephonic device through which requests from claimants are received.

24. The user interface of claim 13 wherein the graphical display is displayed on a screen of a claimant computer device.

25. A system for facilitating automotive glass repair and/or replacement comprising:
a facilitator computer system including a processor running a scripting engine configured to generate a graphical user interface for display on a screen of a computer device;
a display device of a computer system coupled to the facilitator computer system for displaying the generated graphical user interface; and
an input device coupled to the computer system for interacting with the graphical user interface to arrange for repair and/or replacement of damaged automotive glass of a claimant requesting to arrange for repair and/or replacement of damaged automotive glass.

26. The system of claim 25 wherein the claimant holds a policy with an insurance company against which policy the claimant wishes to make a claim for repair and/or replacement of the damaged automotive glass and wherein the facilitator computer system includes memory accessible by the processor and further comprising a script from the insurance company setting forth queries to be made when a claim is made against an insurance policy issued by the insurance company, which script is stored in memory and wherein further the processor accesses the memory to retrieve the stored script and a portion of the stored script appears in the graphical user interface generated by the scripting engine.

27. The system of claim 25 and further comprising a link to a schedule of available appointments for a service provider stored in memory-accessible by the scripting engine and software running on the processor for automatically selecting a service provider to perform the requested automotive glass repair and/or replacement when the claimant has no preference for a specific service provider.

28. The system of claim 25 and further comprising a current schedule for available appointments of two service providers stored in memory accessible by the scripting engine which current schedules are accessed by the scripting engine to display the schedules of the available appointments for the two service providers in a screen of the graphical user interface.

29. The system of claim 25 further comprising:
a database stored in the memory accessible by the processor running the scripting engine, the database including identification data for a plurality of vehicle models that have different versions of glass for different vehicle configurations and glass identifying data regarding each version of glass for each such vehicle configuration;
a glass identification script stored in the memory accessible by the processor running the scripting engine for each vehicle model in the database each such glass identifying script being linked to the identification data for the vehicle model to which it relates and being crafted to elicit answers that identify an appropriate version of glass to replace automotive glass damage of a claimant; and
wherein the scripting engine is configured to access the database and the memory to display a portion of the glass identification script in the graphical user interface.

30. The system of claim 25 and further comprising a script stored in memory accessible by the processor running the scripting engine which accesses the memory to generate a screen of the graphical user interface containing text offering to replace the windshield wiper blades or inserts at the time the automotive glass damage is repaired or replaced.

31. The system of claim 25 further comprising a computer device coupled to the facilitator computer system accessible by a customer representative via the input device, said computer device including the display device on which the graphical user interface is displayed and the input device; and
a customer representative telephonic device accessible by the customer service representative and over which claimant requests are received.

32. The system of claim 31 and further comprising a service provider telephonic device coupled via a network to the customer representative telephonic device.

33. The system of claim 26 and further comprising an insurance company computer system coupled via a network with the facilitator computer system.

34. The system of claim 25 and further comprising a claimant computer system including the display on which the graphical user interface is displayed and the input device and a network coupling the claimant computer system and the facilitator computer system.
